(19) United States
(12) Patent Application Publication
(10) Pub. No.: US 2009/0057093 A1
(43) Pub. Date: Mar. 5, 2009

(54) Bill/coin processing system

(75) Inventors: Toyofumi Iwami, Himeji-Shi (JP); Tasuku Nakamoto, Ako-Shi (JP); Kazuhiro Doi, Himeji-Shi (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Glory Ltd., Himeji-Shi (JP)

(21) Appl. No.: 11/895,852

(22) Filed: Aug. 27, 2007

(51) Int. Cl. G07F 7/04

(52) U.S. Cl. 194/206

(57) ABSTRACT

A banknote and coin handling system for banknotes/coins, has a banknote deposit/payment sorting machine including: a banknote input port; a discriminating portion; a payment discriminating portion; a bundle discriminating portion; a banknote inverting portion; a batch-manner temporary holding portion; plural banknote storage portions; a bundle handling unit; a loose banknote payment port; a banknote bundle payment port; a reject port; a batch-manner storage portion; a banknote bundle storage portion; and a bundle ejection port, and a coin deposit/payment sorting machine including: a loose coin input port; a coin discriminating portion; coin temporary holding portions; a coin batch-manner temporary holding portion; coin storage portions; a coin wrapping portion; a loose coin payment box; a wrapped coin output port; a wrapped coin payment port; a wrapped coin storage box; a bag storage; a reject box; and a return box, wherein various functions can be arbitrarily set.

### TECHNICAL FIELD OF THE INVENTION

The present invention relates generally to a banknote and coin handling system employed in, e.g., a financial institution, and more particularly to a banknote and coin handling system capable of depositing/paying and sorting loose banknotes, bundled banknotes, loose coins and wrapped coins in a variety of modes.

### BACKGROUND OF THE INVENTION

The financial institution such as a bank deals with a variety of currencies such as the loose banknotes, the bundled banknotes, the loose coins and the wrapped coins.

A banknote-related handling apparatus (refer to, e.g., Japanese Patent Application Laid-Open Publication No. 2003-141598) and a coin-related handling apparatus (refer to, e.g., Japanese Patent Application Laid-Open Publication No. 2005-228079) have hitherto been developed, and a banknote and coin handling system is built up by arranging these single-function apparatuses in a side-by-side relation.

The conventional banknote and coin handling system does not, however, unify sizes and functions of these single-function apparatuses, resulting in such problems that space efficiency does not reach an acceptable level, the necessary functions are not realized in some case, and the operations are so complicated as to induce mistakes.

### SUMMARY OF THE INVENTION

Accordingly, the object of the present invention is to provide a banknote and coin handling system which is capable of unified setting of various functions and having compact size.

According to a first aspect of the present invention, there is provided a banknote and coin handling system for handling banknotes and coins, comprising:

banknote handling equipment that processes the banknotes; and

coin handling equipment that processes the coins,

wherein loose banknotes inputted from outside a machine can be paid or stored in any designated form, a form of loose banknotes or a form of bundled banknotes, and

loose coins inputted from outside said machine can be paid or stored within said machine in any designated form, a form of loose coins or a form of wrapped coins.

According to a second aspect of the present invention, there is provided a banknote and coin handling system for handling banknotes and coins, comprising:

a banknote deposit/payment sorting machine including: a banknote input port receiving an input of loose banknotes; a discriminating portion that discriminates between the banknotes taken in from said banknote input port about authenticity, fitness, a front side or back side and denominations; a payment discriminating portion that discriminates between payment target banknotes about the denominations; a bundle discriminating portion that discriminates between the banknote bundles about the denominations; a banknote inverting portion that inverts the banknotes; temporary holding portions according to the denominations;. a batch manner temporary holding portion; a plurality of banknote storage portions that store the banknotes; a bundle handling unit that bundles a predetermined number of banknotes; a loose banknote payment port; a banknote bundle payment port; a reject port; a batch manner storage portion that stores batch manner the loose banknotes and unfit(damaged) banknotes; a banknote bundle storage portion; and a bundle out-of-machine ejection port, and

a coin deposit/payment sorting machine including: a loose coin input port into which the loose coins are inputted; a coin discriminating portion that discriminates between the handling target coins about authenticity, fitness and denominations; coin temporary holding portions according to the denominations; a coin batch manner temporary holding portion that reserves batch manner the coins irrespective of the denominations; coin storage portions that store the coins according to the denominations; a coin wrapping portion that accumulates and packs a predetermined number of coins; a loose coin payment box; a wrapped coin output port; a wrapped coin payment port; wrapped coin storage portions; a bag storage oriented output port; a reject port; a return box; an out-of-machine fraction box; wrapped coin storage portions,

wherein among at least:

(1) a process of storing the lose banknotes inputted into said banknote output port in said banknote storage portions;

(2) a process of tying up the loose banknotes inputted into said banknote input port or the loose banknotes stored in said banknote storage portions into banknote bundles by said bundle handling unit, and outputting the banknote bundles outside said machine;

(3) a process of tying up the loose banknotes inputted into said banknote input port or the loose banknotes stored ins aid banknote storage portions into banknote bundles and storing the banknote bundles in said banknote bundle storage portions;

(4) a process of outputting the banknote bundles stored in said banknote deposit/payment sorting machine outside said machine;

(5) a process of storing said coin storage portions with the loose coins output into said loose coin input port;

(6) a process of wrapping the loose coins inputted into said lose coin input port or the loose coins stored in said coin storage portions and outputting the wrapped coins to the outside;

(7) a process of wrapping the loose coins inputted into said lose coins input port and storing the wrapped coins in said wrapped coin storage portions or said wrapped coin batch manner storage box;

(8) a process of outputting the wrapped coins stored in said wrapped coin storage portions to the outside of said machine; and

(9) a process of outputting the loose coins stored in said coin storage portions to the outside in an as-is state, arbitrary functions can be set.

According to a third aspect of the present invention, there is provided a banknote and coin handling system for handling banknotes and coins comprising:

a banknote deposit/payment sorting machine;

a coin deposit/payment sorting machine combined with said banknote deposit/payment sorting machine;

an operation unit;

a display unit; and

a control unit,

said banknote deposit/payment sorting machine including, as a range of components,: a banknote input port receiving an input of loose banknotes; a discriminating portion that discriminates between the banknotes taken in from said banknote input port about authenticity, fitness, a front side or back side and denominations; a payment discriminating portion that discriminates between payment target banknotes about the denominations; a bundle discriminating portion that discriminates between the banknote bundles about the denominations; a banknote inverting portion that inverts the banknotes; temporary holding portions according to the denominations; a batch manner temporary holding portion; a plurality of banknote storage portions that store the banknotes; a bundle handling unit that bundles a predetermined number of banknotes; a loose banknote payment port; a banknote bundle payment port; a reject port; a batch manner storage portion that stores batch manner the loose banknotes and unfit banknotes; a banknote bundle storage portion; and a bundle out-of-machine ejection port,

said banknote deposit/payment having the following functions such as:

(1) a loose banknote deposit function of taking in the banknotes set in said banknote input port, discriminating between the banknotes by said discriminating portion, rearranging the front side and the back side of the banknote by said banknote inverting portion as the necessity may arise, accumulating fit banknotes in said temporary holding portions or accumulating unfit banknotes in said batch manner reserving portion, storing the fit banknotes in said banknote storage portions or storing the unfit banknotes in said batch manner storage portion, and returning the undiscriminable banknotes and the extremely contaminated banknotes disabled to be treated as the banknotes to said reject port;

(2) a loose banknote input port loading function of taking in the banknotes set in said banknote input port, discriminating between the banknotes by said discriminating portion, rearranging the front side and the back side of the banknote by said banknote inverting portion as the necessity may arise, storing the fit banknotes in said banknote storage portions after being accumulated in said temporary holding portions, and returning the unfit banknotes directly to said reject port;

(3) a loose banknote batch manner storage portion loading function of feeding out the loose banknotes from said batch manner storage portion, discriminating between the banknotes by said discriminating portion, storing the fit banknotes in said banknote storage portions after being accumulated in said temporary holding portions, and returning the unfit banknotes directly to said reject port;

(4) a sorting function of feeding out the banknotes set in said banknote input port, discriminating between the banknotes by said discriminating portion, rearranging the front side and the back side of the banknote by said banknote inverting portion as the necessity may arise, bundling the banknotes of a designated denomination by said bundle handling unit and outputting the bundled banknotes to the outside of said machine from said bundle out-of-machine output port, and returning the banknotes of denominations other than the designated denomination after being accumulated in said temporary holding portions;

(5) a batch manner storage portion sorting function of feeding out the banknotes from said batch manner storage portion, bundling the banknotes of the designated denomination by said bundle handling unit on the basis of a discriminated result of said discriminating portion and outputting said bundled banknotes to the outside of said machine, and returning the banknotes of the denominations other than the designated denomination after being stored in said temporary holding potions corresponding to the denominations;

(6) a loose banknote payment function of feeding out a designated number of banknotes of a designated denomination from said corresponding banknote storage portion, discriminating between the banknotes by said payment discriminating portion and thereafter outputting the banknotes to said loose banknote payment port;

(7) a loose banknote batch manner storage portion collecting function of feeding out the designated number of banknotes of the designated denomination from said corresponding banknote storage portion, discriminating between the banknotes by said payment discriminating portion and thereafter storing the banknotes in said batch manner storage portion;

(8) a loose banknote bundle collecting function of feeding out the designated number of banknotes of the designated denomination from said corresponding banknote storage portion, bundling the banknotes by said bundling portion after discriminating between the banknotes by said payment discriminating portion, and outputting the bundled banknotes to the outside of said machine;

(9) an unfit banknote bundle collecting function of feeding out the unfit banknotes if the unfit banknotes are stored in said batch manner storage portion, discriminating between the banknotes about the denominations by said discriminating portion, bundling the banknotes of a plurality of specified denominations by said bundle handling unit, and returning the banknotes of other unspecified denominations;

(10) an auto collecting function of automatically feeding out the banknotes, if an accumulation count of each of said storage portions becomes equal to larger than fixed count, from said designated banknote storage portion on the basis of a customer's setting, discriminating between the banknotes by said payment discriminating portion, bundling the banknotes by said bundling portion and storing the thus-obtained bundled banknotes in said banknote bundle storage portion, and an intra-machine moving loading function by which a customer himself or herself arbitrarily executes a process of getting the banknotes in said banknote storage portion bundled by said bundle handling unit in accordance with a state of each of said storage portions, and storing the bundled banknotes in said banknote bundle storage portion;

(11) a banknote bundle input port loading function of taking in the loose banknotes set in said banknote input port, discriminating between the banknotes by said discriminating portion, rearranging the front side and the back side of the banknote by said banknote inverting portion as the necessity may arise, bundling the banknotes of the designated denomination by said bundle handling unit, storing the bundled banknotes in said banknote bundle storage portion, and returning the banknotes of the denominations other than the designated denomination to said reject port;

(12) a banknote bundle storage portion loading function of feeding out the loose banknotes stored in said batch manner storage portion, discriminating between the banknotes by said discriminating portion, rearranging the front side and the back side of the banknote by said banknote inverting portion as the necessity may arise, bundling the banknotes of the designated denomination by said bundle handling unit, storing the bundled banknotes in said banknote bundle storage portion, and returning the banknotes of the denominations other than the designated denomination to said reject port;

(13) a banknote bundle out-of-machine loading function of taking in the loading-oriented bundled banknotes set in said bundled banknote payment port, discriminating between the bundled banknotes about the denominations by said bundle discriminating portion, and storing the banknotes of the denomination concerned in a bundled banknote cassette;

(14) a banknote bundle payment function of feeding out the bundled banknotes from said designated bundled banknote cassette, discriminating between the bundled banknotes about the denominations by said bundle discriminating portion, and outputting the banknotes to said bundled banknote payment port;

(15) a bundle payment function of discriminating between the banknotes fed out from said banknote storage portions by said payment discriminating portion, bundling the banknotes of the denomination concerned by said bundling portion, feeding out, in the case of outputting the banknote bundle of the denomination that is not assigned to said banknote bundle storage portion, the banknotes from said banknote storage portion, bundling the fed-out banknotes by said bundle handling unit, and outputting the bundled banknotes to said bundled banknote payment port; and

(16) a banknote bundle output port collecting function of taking out the banknote bundles from said designated banknote bundle storage portion, discriminating between the banknote bundles by said bundle discriminating portion, outputting the banknote bundles from said bundle output port, and outputting the banknote bundles to said bundle output port,

said coin deposit/payment sorting machine including, as a range of components,: a loose coin input port into which the loose coins are inputted; a coin discriminating portion that discriminates between the handling target coins about authenticity, fitness and denominations; coin temporary holding portions according to the denominations; a coin batch manner temporary holding portion that reserves batch manner the coins irrespective of the denominations; coin storage portions that store the coins according to the denominations; a coin wrapping portion that accumulates and packs a predetermined number of coins; a loose coin payment box; a wrapped coin output port; a wrapped coin payment port; wrapped coin storage portions; a bag storage oriented output port; a reject box; a return box; an out-of-machine fraction box; a wrapped coin batch manner storage box,

said coin deposit/payment sorting machine having the following functions such as:

(17) a loose coin deposit function of taking in the loose coins set in said loose coin input port, discriminating between the coins by said coin discriminating portion, storing the fit coins, after being temporarily reserved in said coin temporary holding portions according to the denominations, in said coin storage portions of the denominations concerned, then storing the unfit, after being temporarily reserved in said coin batch manner reserving portion, in said batch manner coin storage box, and returning, if cancelled, all the coins;

(18) a loose coin input port loading function of taking in the loose coins set in said loose coin input port, discriminating between the coins by said coin discriminating portion, storing the fit coins, after being temporarily reserved in said coin temporary holding portion according to the denominations, in said coin storage portions of the denominations concerned, and immediately returning the unfit coins as reject coins;

(19) a sorting function of taking in the loose coins set in said loose coin input port, discriminating between the coins by said coin discriminating portion, wrapping the fit coins by said coin wrapping portion, and outputting the wrapped coins from said wrapped coin output port;

(20) an in-bag function of taking in the loose coins set in said loose coin input port, counting the coins, and outputting the coins from said bag storage oriented output port;

(21) a loose coin payment function of feeding out a designated number of loose coins of a designated denomination, and outputting the loose coins into said payment box;

(22) a loose coin auto collecting function of automatically feeding out the loose coins from said coin storage portions if a storage count in each of said storage portions becomes equal to or larger than a fixed count on the basis of a customer's setting (the setting registered in the device) or when any one of said storage portions becomes full of the coins, wrapping the coins by said coin wrapping portion and storing the coins in said wrapped coin batch manner storage box, and an intra-machine moving loading function by which a customer himself or herself arbitrarily executes a process of wrapping the coins in said coin storage portions by said coin wrapping portion in accordance with states of said respective storage portions and storing the coins in said wrapped coin batch manner storage box;

(23) a loose coin denomination-based storage portion collecting function of feeding out the loose coins from said coin storage portion of the designated denomination, and discharging the coins to said loose coin payment box;

(24) a wrapped coin input port loading function of taking in the loose coins set in said loose coin input port, discriminating between the coins by said coin discriminating portion, wrapping the fit coins by said coin wrapping portion according to the denominations, and storing the wrapped coins in said wrapped coin batch manner storage box;

(25) a wrapped coin payment function of feeding out a designated number of wrapped coins of a designated denomination from said wrapped coin storage portions, and discharging the wrapped coins to said wrapped coin payment port;

(26) a loose coin pack collecting function of feeding out the loose coins from said coin storage portion of the designated denomination, wrapping the loose coins by said coin wrapping portion, and outputting the wrapped coins from said wrapped coin output port to the outside of said machine;

(27) a wrapped coin output port collecting function of feeding out the wrapped coins stored in said wrapped coin storage portions, and outputting the wrapped coins from the wrapped coin output port to the outside of said machine; and

(28) a wrapped coin payment port collecting function of feeding out the wrapped coins stored in said wrapped coin storage portions, and discharging the wrapped coins to said wrapped coin payment port,

wherein arbitrary functions among said functions (1) through (28) can be set.

These types of banknote and coin handling system are capable of setting without any restrictions all the modes with respect to the banknote-related and coin-related deposit/payment and sorting, readily realizing the required functions and, in addition, improving the space efficiency by equalizing at least the heights.

### BRIEF DESCRIPTION OF THE DRAWINGS

FIG. 1 is a perspective view showing an external appearance of a banknote and coin handling system in one embodiment of the present invention;

FIG. 2 is a perspective view showing an external appearance of the banknote and coin handling system in a modified embodiment illustrated in FIG. 1;

FIG. 3 is a perspective view showing an external appearance of the banknote and coin handling system in another modified embodiment illustrated in FIG. 1;

FIG. 4 is a perspective view illustrating only banknote handling components in FIG. 1;

FIG. 5 is a vertical sectional view schematically showing an internal structure of a bundle sorting payment unit in a banknote handling apparatus illustrated in FIG. 1;

FIGS. 6A and 6B are enlarged views of a peripheral portion (when in a banknote bundle storage process) of a banknote bundle carrying path in the bundle sorting payment unit shown in FIG. 5; FIG. 6A is a plan view; and FIG. 6B is a vertical sectional view;

FIGS. 7A and 7B are enlarged views of the peripheral portion (when in a banknote bundle ejecting process) of the banknote bundle carrying path in the bundle sorting payment unit shown in FIG. 5; FIG. 7A is a plan view; and FIG. 7B is a vertical sectional view;

FIG. 8 is a plan view showing an operation of a nipping portion of a bundle carrying unit common to the bundle sorting payment unit and a loose banknote deposit/payment unit in terms of a relation with part of the respective handling units;

FIG. 9 is a vertical sectional view schematically illustrating an internal structure of the loose banknote deposit/payment unit in the banknote handling apparatus illustrated in FIG. 1;

FIG. 10 is a schematic view of the internal structure, showing an internal structure of a new banknote payment unit shown in FIG. 1 and a flow of the banknotes;

FIGS. 11A-11C are views showing in sequence how an out-of-machine bundle loading process is executed by a banknote bundle handling unit illustrated in FIG. 5;

FIGS. 12A-12C are views showing in sequence how an auto careful inspection process is executed by the banknote bundle handling unit illustrated in FIG. 5;

FIGS. 13A-13C are views showing in sequence how an auto allocation process is executed by the banknote bundle handling unit illustrated in FIG. 5;

FIG. 14 is a vertical sectional view schematically showing an internal structure of a coin handling unit partly constituting the banknote and coin handling system illustrated in FIG. 1;

FIG. 15 is a plan view schematically showing a main configuration in FIG. 14;

FIG. 16 is a side view showing a layout of coin storage portions of the lose coin deposit/payment unit;

FIG. 17 is a sectional view of the main configuration related to storing wrapped coins as viewed from a right side front side in FIG. 14; and

FIG. 18 is a perspective view showing one example of a wrapped coin storage portion.

### DETAILED DESCRIPTION OF THE EXEMPLARY EMBODIMENT

An in-depth description of an embodiment of a banknote and coin handling system according to the present invention will hereinafter be made.

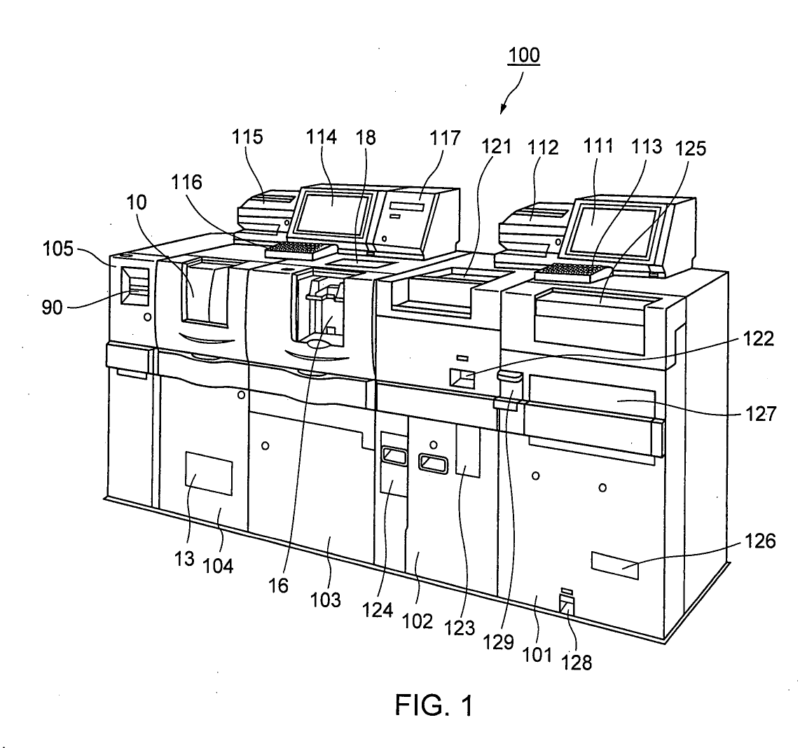

FIG. 1 is a perspective view illustrating architecture of a whole banknote and coin handling system 100 according to the present invention. The banknote and coin handling system 100 is a side-by-side installment type of banknote and coin handling system including five handling apparatuses 101-105 that are connected to each other. The handling apparatuses 101-105 are, from the right side, a packaged coin payment unit 101, a loose coin deposit/payment unit 102, a loose banknote deposit/payment unit 103, a bundle sorting payment unit 104 and a new banknote payment unit 105. The loose banknote deposit/payment unit 103, the bundle sorting payment unit 104 and the new banknote payment unit 105 build up a banknote deposit/payment sorting machine, and the packaged coin payment unit 101 and the loose coin deposit/payment unit 102 build up a coin deposit/payment sorting machine.

The respective apparatuses are coincident in terms of heights of their housings, and can be connected to each other with a sense of uniformity. It is desirable that depths of the individual apparatuses be equalized. The three banknote-oriented apparatuses and the two coin-oriented apparatuses can be respectively connected, and a system arrangement may be done irrespective of a right-and-left positional relation between the banknote-oriented units and the coin-oriented units. Therefore, the architecture in FIG. 1 can be changed without any restrictions according to the necessity, such as a layout of replacing the banknote-oriented units and the coin-oriented units with each other.

Upper surfaces of the housings of the packaged coin payment unit 101 and the loose coin deposit/payment unit 102 are provided with a terminal unit 111 for displaying and operating a screen, a printer unit 112 that performs printing and a keyboard 113. Upper surfaces of the housings of the loose coin deposit/payment unit 102 and the loose banknote deposit/payment unit 103 (the loose banknote deposit/payment unit 103 and the bundle sorting payment unit 104) are likewise provided with a terminal unit 114, a printer unit 115 and a keyboard 116. Provided further is a post unit 117 into which unfit banknotes, checks, etc are inserted.

The present embodiment involves providing the terminal units and the printer units by twos, however, these units are the same other than such setting that one units are used as main units while the others are employed as sub-units.

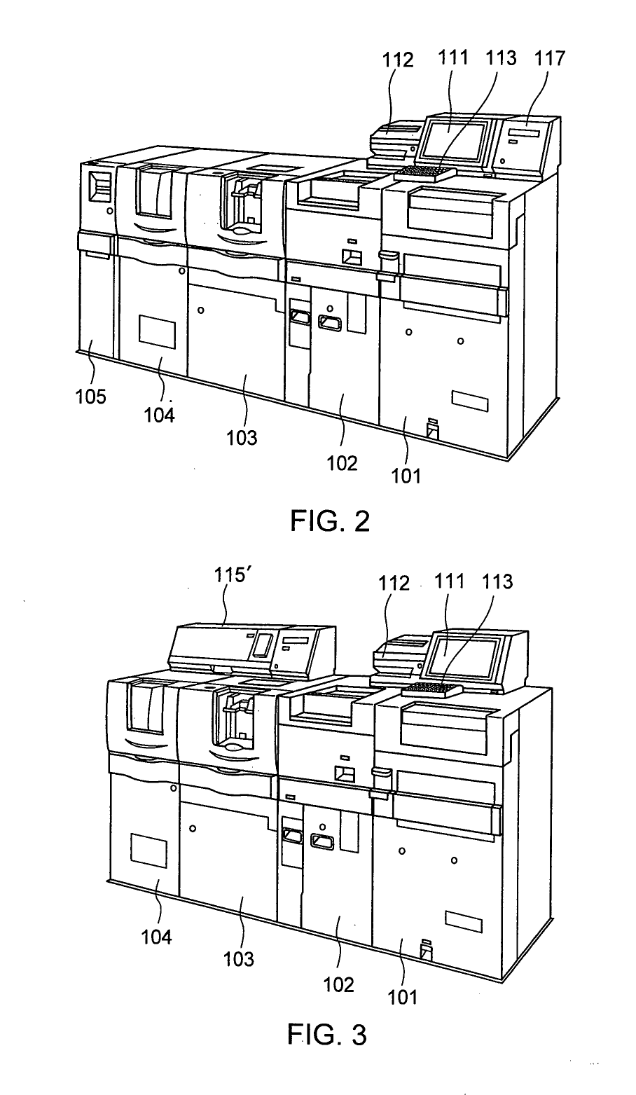

Accordingly, as illustrated in FIG. 2, the system can be so configured as to include only one set of the terminal unit 111, the printer unit 112, keyboard 113 and the post unit 117.

Note that the new banknote payment unit 105 is illustrated by way of an example of a vertical placement type in FIGS. 1 and 2, and can be also placed as a lateral placement type 105′. In this case, an occupied area can be reduced, and the terminal unit 111, the printer unit 112 and the keyboard 113 are provided by ones in terms of the space.

Each of the handling units will hereinafter be described.

1. Banknote Handling Unit

As described above, the banknote and coin handling system 100 according to the present invention is roughly constructed of the loose banknote deposit/payment unit 103, the bundle sorting payment unit 104, the new banknote payment unit 105, the packaged coin payment unit 101 that deals with the coins and the loose coin deposit/payment unit 102. In the following discussion, however, the loose banknote deposit/payment unit 103, the bundle sorting payment unit 104 and the new banknote payment unit 105, which build up the banknote deposit/payment sorting machine of the banknote-oriented units, will be explained.

(1) Bundle Sorting Payment Unit 104

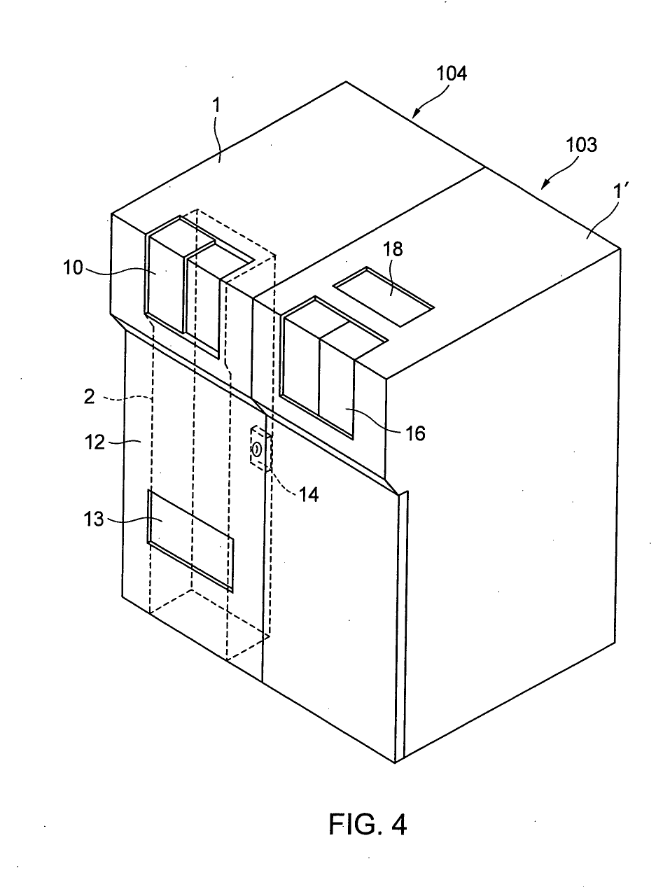

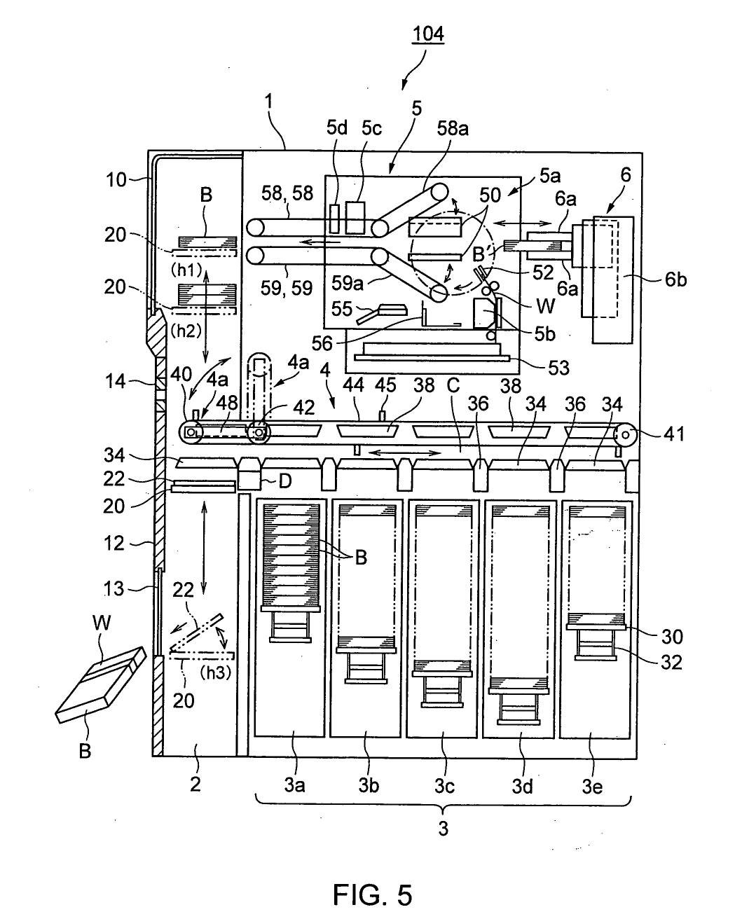

FIG. 1 illustrates an external appearance of the whole system. FIG. 4 illustrates external appearances of the loose banknote deposit/payment unit 103 and the bundle sorting payment unit 104. FIG. 5 schematically illustrates an internal structure thereof. As shown in FIGS. 1, 4 and 5, the bundle sorting payment unit 104 includes a bundle carrying unit 6 (which will be described later on) for carrying in a loose banknote bundle B′ from the loose banknote deposit/payment unit 103 that will be explained later on, a binding print unit 5 that binds a predetermined number of loose banknote bundles B′ with a binding band (binder) W into a banknote bundle. B and performs a predetermined print on the binding band W, a banknote bundle ascending/descending path (banknote bundle accepting unit) 2 for moving the banknote bundle B undergoing the binding/printing process by the binding print unit 5 in a vertical direction, and a banknote bundle storage unit 3 that stores the banknote bundles B. Further, the bundle sorting payment unit 104 includes a carrying unit (loading unit) 4 that moves the banknote bundle B in a horizontal direction between the ascending/descending path 2 and the storage unit 3, and a bundle discriminating unit (discriminating unit) D that discriminates between denominations of the banknote bundles B carried by the carrying unit 4.

A housing 1 illustrated in FIG. 5 houses the ascending/descending path 2, the storage unit 3, the carrying unit 4 and the binding print unit 5, and the bundle carrying unit 6 moves within the housing 1 (and a housing 1′ for the loose banknote deposit/payment unit 103, which will be described later on).

The banknote ascending/descending path 2 is disposed along the front side of the housing 1, and is provided inside with an ascending/descending stage (loading unit) 20 that ascends and descends while being loaded with the banknote bundles B. An inclined plate 22 swingable to tilt the front is provided on an upper surface side of the ascending/descending stage 20. An upper portion of the ascending/descending path 2 is communicable with the outside via a shutter opening/closing type of a bundle payment port 10. Moreover, a lower part of the ascending/descending path 2 is opened on the whole by opening forward an opening/closing door 12 attached with a locking device 14 and is also communicable partially with the outside via a shutter opening/closing type of a bundle out-of-machine ejection port 13 provided at the opening/closing door 12.

The banknote bundle storage unit 3 has five bundle storage portions 3a-3e disposed in line in back-and-forth directions. The bundle storage portions 3a-3e are classified into the four denomination bundle storage portions 3a-3d for storing the banknote bundles B on a denomination-by-denomination basis and the batch manner bundle storage portion 3e for storing batch manner the banknote bundles B in a multi-denomination state. Note that the functions of the respective storage portions and the denominations can be flexibly set and changed, and it is feasible to provide a plurality of storage portions for specified denominations and provide a plurality of batch manner storage portions.

Each of the bundle storage portions 3a-3e is of an independently attachable/detachable cassette type, with its upper end portion being opened, and is provided inside with an ascending/descending stage 300 fitted with a pantograph mechanism 32.

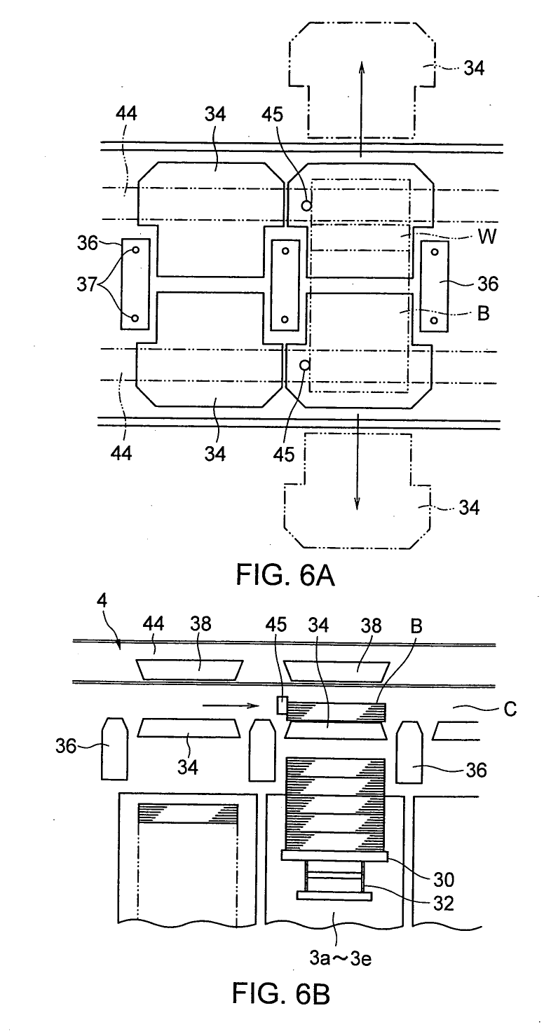

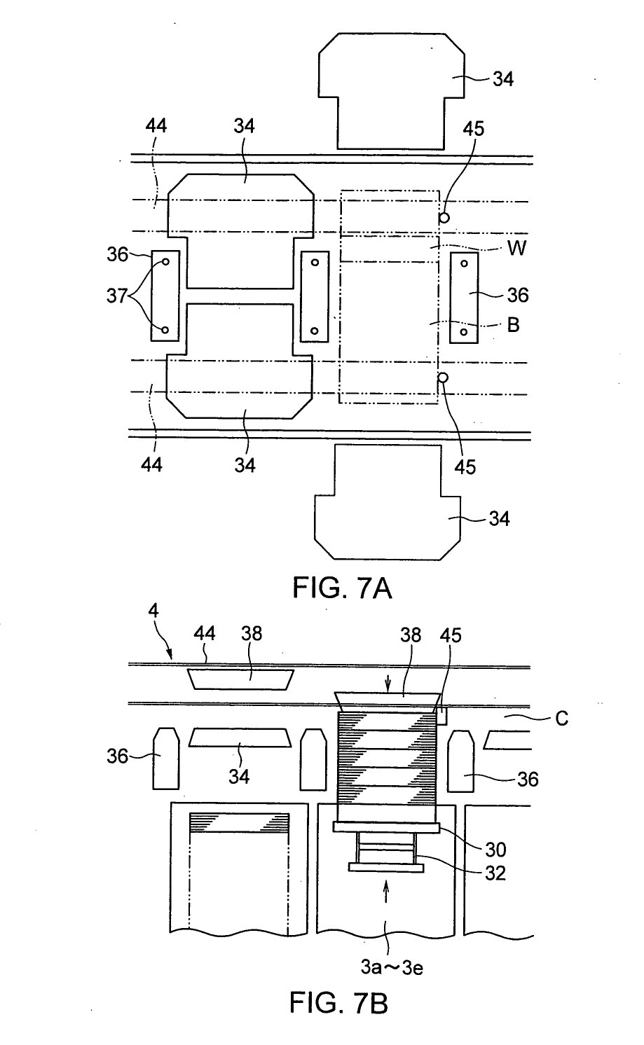

FIGS. 6 and 7 are diagrams each showing in enlargement peripheral portions of the banknote bundle carrying path in the banknote handling unit illustrated in FIG. 5 when inserting the banknote bundle and when ejecting the banknote bundle. FIGS. 6A and 7A are plan views, and FIGS. 6B and 7B are vertical sectional views.

The carrying unit 4 has a pair of left-and-right conveying belts 44 (see FIG. 6A) extending horizontally to within the ascending/descending path 2 from above the storage unit 3. Each conveying belt 44 is stretched between a pair of pulleys 40, 41 and is provided with four pieces of pins 45 protruding at predetermined intervals. For each of the conveying belts 44, a third pulley 42 is disposed between the pair of pulleys 40, 41 (just posterior to the ascending/descending path 2). Then, a lever 48 connecting the two pulleys 40, 42 on the side of the ascending/descending path 2 is swingable through 90 degrees upward about an axis of rotation of the pulley 42. With this contrivance, the portion, on the side of the ascending/descending path 2, of the carrying unit 4 swings to a vertical retreat position from a horizontal carry position, thereby forming a swing retreat portion 4a enabling the retreat from within the ascending/descending path 2.

A pair of opening/closing plates 34 (see FIG. 6) opening and closing rightward and leftward is provided respectively between the carrying unit 4 and each of the bundle storage portions 3a-3e. Moreover, a pair of opening/closing plates 34 is similarly provided between the swing retreat portion 4a of the carrying unit 4 and the lower part of the ascending/descending path 2. A partition plate 36 is provided respectively between the opening/closing plates 34 corresponding to the individual bundle storage portions 3a-3e. A pair of sensors 37 (FIG. 6A) for detecting passage and a skew of the banknote bundle B is provided on an upper edge face of each partition plate 36. The bundle discriminating unit D is disposed between the opening/closing plate 34 on the bundle storage portion 3a and the opening/closing plate 34 within the ascending/descending path 2.

A carrying path C along which to convey the banknote bundle B in the horizontal direction is formed between the opening/closing plate 34, the partition plate 36, the bundle discriminating unit D and the carrying unit 4. To be specific, the banknote bundle B, which receives carrying force from a pin 45 of the conveying belt 44 within the carrying path C, is carried while sliding on the opening/closing plate 34 etc (see FIG. 5). Note that a pressing force detection plate 38 in a face-to-face relationship with the opening/closing plate 34 on each of the bundle storage portions 3a-3e is disposed between the pair of conveying belts 44.

Herein, an explanation of how the banknote bundle B is inserted into and ejected from each of the bundle storage portions 3a-3e, will be made with reference to FIGS. 6 and 7. Note that the discussion will proceed in a way that does not specify any one of the bundle storage portions but generically applies the bundle storage portions 3a-3e in FIGS. 6 and 7.

When storing the banknote bundle B as shown in FIG. 6, to begin with, the banknote bundle B is carried by the carrying unit 4 to above the opening/closing plates 34 corresponding to the should-be-stored bundle storage portions 3a-3e. On the other hand, within the bundle storage portions 3a-3e, the ascending/descending stage 30 rises to a height at which to receive the banknote bundle B to be stored (FIG. 6B). In this state, the pair of opening/closing plates 34 is opened rightward and leftward (FIG. 6A), thereby dropping the banknote bundle B down onto the ascending/descending stage 30 (on the banknote bundle B stacked on this stage 30). Thereafter, the pair of opening/closing plates 34 is closed, and the ascending/descending stage 30 descends to a predetermined position, thus completing the storage of the banknote bundle B.

Next, when ejecting the banknote bundle B as shown in FIG. 7, the opening/closing plates 34 above the bundle storage portions 3a-3e from which the banknote bundle B should be ejected, open rightward and leftward, and the ascending/descending stage 30 on which the banknote bundle B is placed ascends. At this time, the pressing force detection plate 38 descends synchronizing with the opening of the opening/closing plates 34 and regulates a rising height of the banknote bundle B. To be specific, the pressing force detection plate 38, when pushed up by the uppermost banknote bundle B, functions as a switch that stops the ascendance of the stage 30. With this operation, only the uppermost banknote bundle B can be ejected onto the carrying path C, thus enabling the banknote bundles B to be carried on a bundle-by-bundle basis by the carrying unit 4.

Subsequently, the binding print unit 5 illustrated in FIG. 5 includes a binding unit 5a for binding a loose banknote bundle B′ carried by the bundle carrying unit 6 with a binding band W into the banknote bundle B, and a printer (printing unit) 5b for performing a predetermined print etc on the binding band W of the banknote bundle B. The binding unit 5a has a nipping unit 50 that nips the loose banknote bundle B′, and a rotary arm 52 for winding the binding band W (drawn from a roll 53) around the nipped bindle B′. This binding unit 5a can involve using a known type of binding device. The binding unit 5a has, in addition, a bonding trowel 55 that bonds the edges of the wound binding band W, and a cutter 56 that cuts the binding band W on the bundle-by-bundle basis. Note that a band winding position of the bundled banknotes is changeable because of differences depending on countries, districts, etc.

Then, a content of how the band is wound can be changed depending on a characteristic of the banknotes that should be bundled. For example, a positional change of winding the bands around fit (normal) banknotes and unfit banknotes facilitates the banknote management within a financial institution, and hence, for example, it is possible to control winding the band around the fit banknotes in a position slightly deviating from the center and around the unfit banknotes at the center.

Further, a sheet of winding band paper may be fixed irrespective of the denominations, however, it is feasible to facilitate distinction between the denominations of the bundled banknotes and the banknote management as well by use of the sheets of winding band paper different according to the categories of the denominations in a way that enables plural types of winding band paper to be supplied.

In another mode, the same winding band paper is applied to each of the denominations, and a post-bundling winding band paper can be marked with a color corresponding to the denomination.

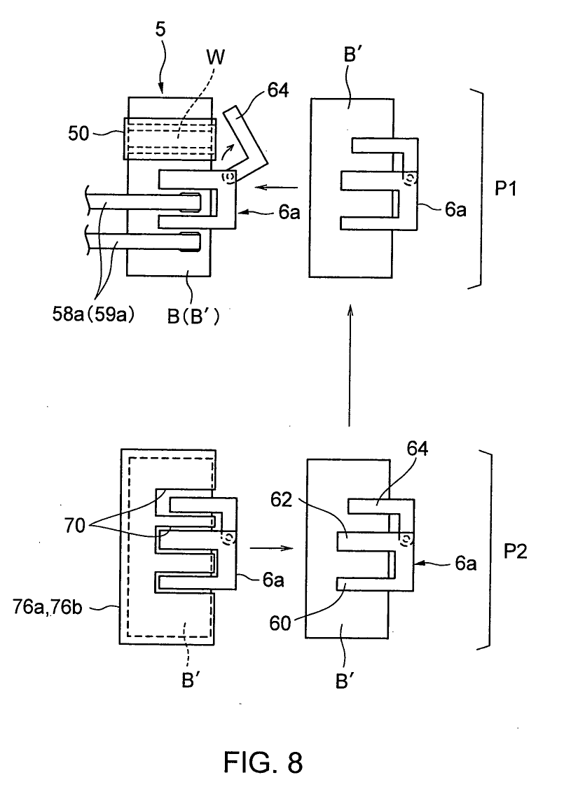

Further, the binding print unit 5 is provided with conveying belts 58, 59 for conveying the tied-up banknote bundle B to the upper portion of the ascending/descending path 2. An institution name stamp 5c for printing a name of the financial institution on the binding band W of the banknote bundle B and an unfit banknote stamp 5d for pressing an unfit banknote mark on the binding band W that binds the unfit banknotes, are disposed neighboring to the upper conveying belt 58 thereof. Note that swing retreat portions 58a, 59a (see FIG. 8) retreating to the outside when winding the binding band W are formed on the sides corresponding to nipping portions 50 of the conveying belts 58, 59.

It is to be noted that the carrying unit 4 is not limited to the unit employing the conveying belt 44 fitted with the pin 45 described above and may, if capable of moving the banknote bundle B in reciprocation along the carrying path C, take other constructions. Moreover, the bundle sorting payment unit 104 can be made independent as, e.g., a device that process only the already tied-up banknote bundle, and, in this case, it is possible to omit the binding print unit 5 and bundle carrying unit 6 in separation from the loose banknote deposit/payment unit 103. Moreover, the banknote bundle storage unit 3 may include, without being limited to the configuration having only one batch manner storage portion 3e, a plurality of batch manner bundle storage portions.

Herein, the bundle carrying unit 6 common to the bundle sorting payment unit 104 and to the loose banknote deposit/payment unit 103 will be described with reference to FIGS. 5 and 8. The bundle carrying unit 6 includes a pair of upper and lower nipping portions 6a that nip the loose banknote bundle B′, and a moving portion 6b (FIG. 5) that moves these nipping portions 6a. The moving portion 6b of the bundle carrying unit 6 moves the nipping portions 6a backward and forward in the front-and-rear directions, and moves the nipping portions 6a in the right-and-left directions between the bundle sorting payment unit 104 and the loose banknote deposit/payment unit 103. Each of the nipping portions 6a has, as illustrated in FIG. 8, three pieces of nipping pawls 60, 62, 64 extending forward. The right-end nipping pawl 64 thereof is enabled to swing-retreat backward in order to avoid interference with the nipping portions 50 of the binding print unit 5 in the bundle sorting payment unit 104.

(2) Loose Banknote Deposit/Payment Unit 103

Next, a specific construction of the loose banknote deposit/payment unit 103 illustrated in FIG. 1 will be explained.

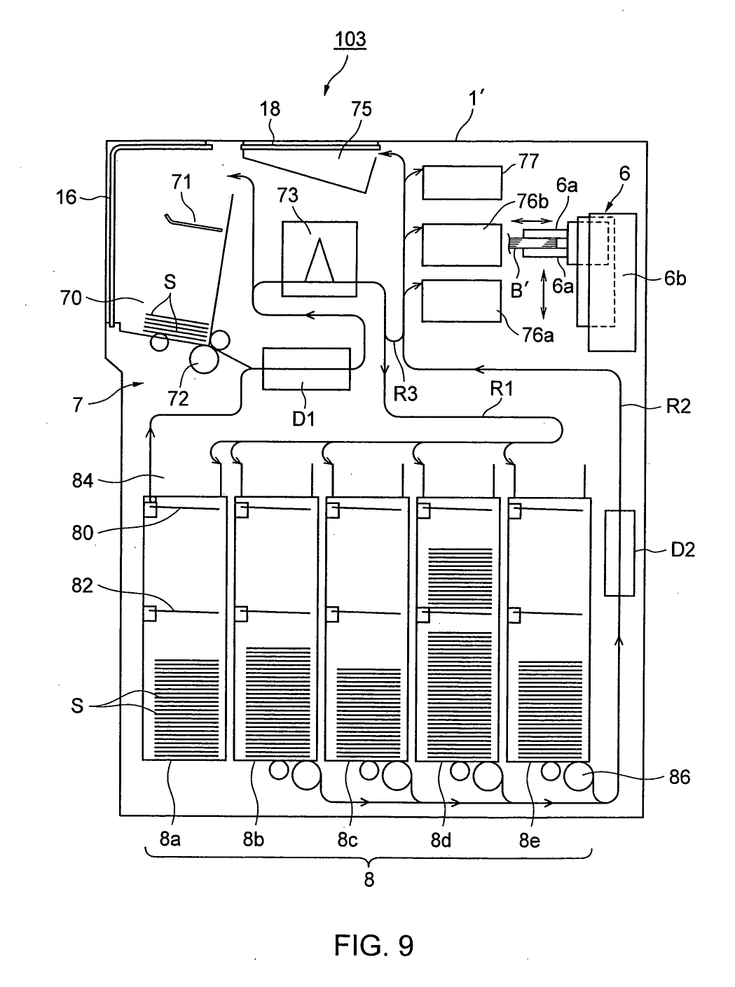

FIG. 9 schematically shows an internal structure of the loose banknote deposit/payment unit 103. Referring to FIG. 9, the loose banknote deposit/payment unit 103 includes a deposit/payment handling unit 7 and a banknote storage unit 8 provided at an upper part and a lower part within a housing 1′. The deposit/payment handling unit 7 has a deposit accumulating portion 70 and a reject accumulating portion 71 that correspond to the front upper part of the housing 1′, and a payment accumulating portion 75 corresponding to the upper face part of the housing 1′. The deposit accumulating portion 70 and the reject accumulating portion 71 are openable to the outside via a shutter opening/closing type of banknote insertion port 16 (see FIGS. 1 and 4). Moreover, the payment accumulating portion 75 is also openable to the outside via a shutter opening/closing type of loose banknote payment port 18 (see FIG. 4).

On the other hand, the banknote storage unit 8 includes one batch manner storage portion 8a and four banknote storage portions 8b-8e, which are arranged in line in the front-and-rear directions. The batch manner storage portion 8a is of an attachable/detachable cassette type, wherein the banknotes in mixed denominations are batch manner taken in from the upper part thereof and fed out from the upper part. The four banknote storage portions 8b-8e are stored with the loose banknotes according to the denominations of the banknotes. Upper edge parts of the batch manner storage portion 8a and of the banknote storage portions 8b-8e are provided with a temporary holding portion 84, and lower edge parts of the banknote storage portions 8b-8e are respectively provided with feeding members 86. Further, movable separators 80, 82 are provided by two stages in interiors of the storage portions 8a-8e.

The number of the banknote storage portions is, though herein exemplified by “4”, normally set equal to or larger the number of the denominations of the banknotes actually issued. For example, in the case of the U.S.A., there are seven denominations such as 1 dollar, 2 dollars, 5 dollars, 10 dollars, 50 dollars and 100 dollars. In the case of China, there are six denominations such as 1 yuan, 2 yuan, 5 yuan, 10 yuan, 50 yuan and 100 yuan. Hence, the banknote storage portions, of which the number is set equal to or larger than the number of these denominations, are provided.

The banknotes having large quantities of circulations can be smoothly arranged in their deposits and payments by increasing, if extremely different in terms of the quantities of circulations of those denominations, the number of the banknote storage portions for the banknotes having the large quantities of circulations. For example, in the case of U.S. dollar, if the 1-dollar banknotes have an overwhelming quantity of circulation, one more banknote storage portion is prepared for 1 dollar, and totally 8 pieces of banknote storage portions can be provided. Furthermore, conversely if the quantities of circulations of 50 dollars and 100 dollars are small, the banknotes of these denominations are stored in mixture, thus enabling the two storage portions to be ensured for the 1-dollar banknotes while keeping the seven storage portions unchanged. The number of the storage portions can be further reduced based on this idea.

The deposit accumulating portion 70 provided corresponding to the banknote insertion port 16 is provided with a feeding member 72, and a deposit carrying path R1 is formed between the feeding member 72 and the temporary holding portion 84 for the storage portions 8a-8e. A deposit discriminating portion D1 and a front side/back side inverting portion 73 are provided midways of the deposit carrying path R1. Further, a payment carrying path R2 is formed between the feeding members 86 and the payment accumulating portion 75. A payment discriminating portion D2 is provided midways of the payment carrying path R2, and branches off to two stackers 76a, 76b and to a payment eject box 77 anterior to the payment accumulating portion 75. The deposit carrying path R1 also branches off to the reject accumulating portion 71 between the deposit discriminating portion D1 and the front side/back side inverting portion 73. Moreover, a bypass carrying path R3 branching off from the deposit carrying path R1 downstream of the front side/back side inverting portion 73 gets confluent with the payment carrying path R2 upstream of the stacker 76a.

In the rear of the stackers 76a, 76b, the bundle carrying unit 6 is enabled to enter. The pair of nipping portions 6a of the bundle carrying unit 6 is also movable up and down with respect to the moving portion 6b, corresponding to the two pieces of upper and lower stackers 76a, 76b. Further, as illustrated in FIG. 8, three lines of notched portions 70 corresponding to the three nipping pawls 60, 62, 64 are formed in each of the stackers 76a, 76b. The nipping pawls 60, 62, 64 of the pair of nipping portions 6a of the bundle carrying unit 6 nip the loose banknote bundle B′ (via the notched portions 70) accumulated in the stackers 76a, 76b, and can thus pull the banknote bundle B′ backward.

Herein, an operation of the loose banknote deposit/payment unit 103 will be briefly described.

Loose banknotes S inserted into the deposit accumulating portion 70 via the banknote insertion port 16 are fed on a sheet-by-sheet basis by the feeding member 72 and are carried along the deposit carrying path R1. These loose banknotes S are discriminated between their denominations by the deposit discriminating portion D1, and undiscriminable deposit reject banknotes are returned to the reject accumulating portion 71. Further, the banknote S opposite in its front side and back side to the predetermined direction is inverted by the front side/back side inverting portion 73 and sent to the downstream side. The loose banknotes S sent via the deposit carrying path R1 to the storage unit 8 are stored in the storage portions 8b-8e corresponding to the denominations thereof or in the batch manner storage portion 8a. On this occasion, the loose banknotes S are, after being accumulated in the temporary holding portion 84, stored in the storage portions 8b-8e or in the batch manner storage portion 8a by dint of the operations of the movable separators 80, 82.

On the other hand, the loose banknotes S taken out of the upper part of the batch manner storage portion 8a are carried to the deposit discriminating portion D1. The loose banknotes S fed out on the sheet-by-sheet basis by the lower feeding members 86 from the storage portions 8b-8e are carried along the payment carrying path R2. These loose banknotes S are discriminated between their denominations by the payment discriminating portion D2. The payment reject banknotes undiscriminable to the discriminating portions D1, D2 are accumulated in the payment reject box 77. The loose banknotes S other than those undiscriminable banknotes are accumulated in the payment accumulating portion 75 or in any one of the stackers 76a, 76b in accordance with the purpose. The payment banknotes accumulated in the payment accumulating portion 75 are taken out via the loose banknote payment port 18. Further, the loose banknotes S inserted into the deposit accumulating portion 70 can be also accumulated directly in the stackers 76a, 76b without via the storage unit 8 by making use of the bypass carrying path R3.

(3) New Banknote Payment Unit 105

The new banknote connotes an unused banknote or a banknote close to the unused banknote. The new banknote payment unit 105 is a single-function machine that simply pays out the new banknotes prepared beforehand in the cassette in response to a request because of high demands for the new banknotes. The new banknote payment unit 105 links up with neither the loose banknote deposit/payment unit 103 nor the bundle sorting payment unit 104.

As illustrated in FIG. 1, only a new payment port 90 is formed in the front panel of the housing.

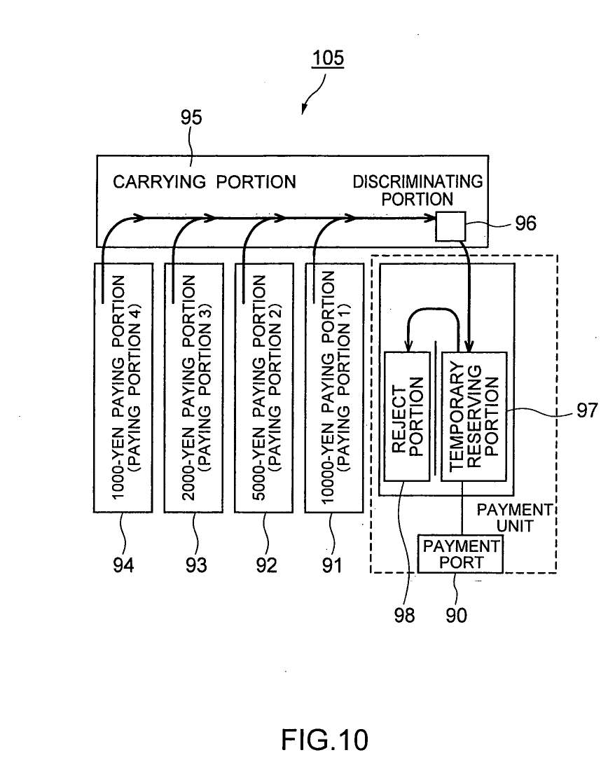

FIG. 10 is a schematic internal configuration diagram showing an internal configuration of the new banknote payment unit 105 and a flow of the banknotes.

Four cassette type payment units 91-94 previously stored with the new banknotes, wherein, for example, the first payment unit 91 is assigned to the banknotes of 10000 Yen, the second payment unit 92 is to the banknotes of 5000 Yen, the third payment unit 93 is to 2000 Yen, and the fourth payment unit 94 is to 1000 Yen.

Necessary sheets of banknotes are fed out of these payment units in response to an instruction, then carried by the carrying portion 95, and confirmed to be of the denomination instructed to be fed out but not to be the reject banknotes by a discriminating portion 96. All the carried banknotes, though reserved in the temporary holding portion 97, are paid out of the new banknote payment port if none of problems arise.

While on the other hand, if identified with the reject target banknotes, these banknotes reserved in the temporary holding portion are carried to the reject portion 98.

The types of the banknotes dealt with by the new banknote payment unit differ depending on the countries, and, as described above, the U.S.A. has the seven types of banknotes while China has the six types of banknotes. The types of the banknotes are, however, properly selected corresponding to the number of the payment units. The payment units can be assigned to the banknotes exhibiting a high frequency of usage and to the large denomination banknotes frequently used for special applications such as congratulations money. Further, as in the case of 1-dollar banknotes in the U.S.A. that has an overwhelmingly large quantity of circulation, a plurality of portions among the four payment units can be also assigned to 1-dollar banknotes.

The new banknote payment unit is neither indispensable for the system nor often installed as the case may be.

[Handling Contents]

Next, contents of a variety of processes by the banknote handling apparatus 100 according to the present embodiment will be explained in the way of roughly classifying the processes into the following processes (1)-(6). These processes are executed under control of a control unit of a computer etc on the basis of inputs etc from keyboards 113, 116 defined as operating units shown in FIG. 1, and the handling contents are displayed on display screens 111, 114 according to the necessity. Note that the descriptions of the respective processes will be made in a way that properly omits the explanations of the overlapped contents with those described earlier.

1. Process of Tying Up Loose Banknotes into Banknote Bundle and Ejecting Banknote Bundle outside

1.1 Sorting Process

A sorting process is that the loose banknotes S (out-of-machine banknotes) inserted into the deposit accumulating portion 70 of the loose banknote deposit/payment unit 103 are sorted into the banknote bundles B (eject banknote bundles), which are ejected by the bundle sorting payment unit 104 from the bundle out-of-machine ejection port 13.

To be specific, at first, in the loose banknote deposit/payment unit 103 illustrated in FIG. 3, the loose banknotes S inserted into the deposit accumulating portion 70 are fed out on the sheet-by-sheet basis by the feeding member 72 and carried along the deposit carrying path R1. The loose banknotes S (excluding the banknotes returned to the reject accumulating portion 71) passing through the deposit discriminating portion D1 and the front side/back side inverting portion 73, are accumulated in the stackers 76a, 76b via the payment carrying path R2 from the bypass carrying path R3. The loose banknote bundles B′ accumulated in the stackers 76a, 76b are carried to the bundle sorting payment unit 104 by the carrying unit 6.

The loose banknote bundles B′ carried to the bundle sorting payment unit 104 illustrated in FIG. 4 are fed into the binding print unit 5 by the carrying unit 6. The fed-in loose banknote bundles B′ are tied up with the binding band W and fed as the banknote bundle B to the ascending/descending path 2 by the conveying belts 58, 59. In the meanwhile, the binding band W is printed with a predetermined print by the printer 5b and is stamped with a financial institution name stamp 5C and further stamped, if necessary, with an unfit banknote stamp 5d.

The banknote bundle B fed out to the ascending/descending path 2 is placed on the ascending/descending stage 20 standing by in a receiving position h1. In the case of taking the banknote bundle B out of the bundle payment port 10, after the stage 20 has descended to a payment position h2, a shutter of the bundle payment port 10 opens, whereby the banknote bundle B is taken out of the bundle payment port 10. Further, in the case of ejecting the banknote bundle B from the bundle out-of-machine ejection port 13, the stage 20 descends to a lower position h3, and, after a shutter of the bundle out-of-machine ejection port 13 has opened, the inclined plate 22 above the stage 20 gets tilted with the front being lowered, whereby the banknote bundle B is ejected from the bundle out-of-machine ejection port 13.

1.2 Bundle Collecting Process

A bundle collecting process is that the loose banknotes S (intra-machine banknotes) stored in the storage unit 8 of the loose banknote deposit/payment unit 103 are ejected from the bundle out-of-machine ejection port 13 in order to collect the banknotes S as the banknote bundle B (eject banknote bundle) in the bundle sorting payment unit 104. Specifically, to start with, in the loose banknote deposit/payment unit 103 shown in FIG. 9, the loose banknotes S stored in any one of the storage portions 8b-8e are fed out on the sheet-by-sheet basis by the feeding members 86 and carried along the payment carrying route R2. The loose banknotes S (excluding those sent to the payment reject box 77) passing through the payment discriminating portion D2 are accumulated in the stackers 76a, 76b. The loose banknote bundles B′ accumulated in the stackers 76a, 76b are carried to the bundle sorting payment unit 104 by the carrying unit 6.

Then, the loose banknote bundles B′ carried to the bundle sorting payment unit 104 illustrated in FIG. 5 are, in the same way as in the case of 1.1 Sorting Process, fed out as the banknote bundles B to the ascending/descending path 2 and ejected from the bundle out-of-machine ejection port 13.

Note that a variety of operations can be applied to this bundle collection, and, for example, in the case of targeting the bundle at only the banknotes of 100 yuan in China, it is feasible to collect fractions of the banknote of 100 yuan, which are, i.e., the banknotes of 50 yuan, 20 yuan and 10 yuan, in the batch manner storage portion and to collect the banknotes of the denominations designated by a customer in the way of carrying these banknotes to the loose banknote payment port 18.

1.3 Bundle Payment Process

A bundle payment process is a process of paying, as the banknote bundle B (ejection banknote bundle), the loose banknotes S (intra-machine banknotes) by the bundle sorting payment unit 104, which are stored in the banknote storage unit 8 of the loose banknote deposit/payment unit 103 and taking the banknote bundle B out of the bundle payment port 10.

To be specific, at first, in the loose banknote deposit/payment unit 103 illustrated in FIG. 9, in the same way as in the case of 1.2 Bundle Collecting Process, the loose banknotes S stored in any one of the storage portions 8b-8e are accumulated in the stackers 76a, 76b and carried as the loose banknote bundles B′ to the bundle sorting payment unit 104 by the carrying unit 6.

Then, the loose banknote bundles B′ carried to the bundle sorting payment unit 104 illustrated in FIG. 5 are, in the same way as in the case of 1.1 Sorting Process, fed out as the banknote bundles B to the ascending/descending path 2 and taken out of the bundle payment port 10.

2. Process of Tying Up Loose Banknotes into Banknote Bundle and Storing Banknote Bundle

2.1 Bundle Loading Process

A bundle loading process is that the bundle sorting payment unit 104 stores the banknote bundle storage unit 3 with the loose banknotes S (out-of-machine banknotes), as the banknote bundle B (storage banknote bundle), inserted into the deposit accumulating portion 70 of the loose banknote deposit/payment unit 103.

Specifically, at the first onset, in the same way as in the case of 1.1 Sorting Process, the inserted loose banknotes S are tied up into the banknote bundle B. Namely, in the loose banknote deposit/payment unit 103, the loose banknotes S inserted into the deposit accumulating portion 70 are accumulated in the stackers 76a, 76b and carried as the loose banknote bundles B′ by the carrying unit 6 to the bundle sorting payment unit 104. Then, the loose banknote bundles B′ carried to the bundle sorting payment unit 104 shown in FIG. 5 are fed out as the banknote bundles B to the ascending/descending path 2 via the binding print unit 5.

The banknote bundles B fed out to the ascending/descending path 2 are, after being placed on the ascending/descending stage 20 standing by in the receiving position h1, lowered down to a height of the carrying path C. At this time, the opening/closing plates 34 for the ascending/descending path 2 are opened. Further, the swing retreat portion 4a of the carrying unit 4, which has retreated in preparation for the passage of the stage 20, swings to the carrying position and enters the ascending/descending path 2. Then, the banknote bundles B are carried along the carrying path C to the side of the banknote bundle storage unit 3 (the right side in FIG. 3) by driving the conveying belt 44 of the carrying unit 4. At this time, the bundle discriminating unit D discriminates between the denominations of the banknote bundles B.

When the banknote bundles B reach above the opening/closing plates 34 corresponding to the storage portions 3a-3e to which the banknote bundles B should be stored, the carrying belt 44 stops, then the opening/closing plates 34 open, and the banknote bundles B are stored in the storage portions 3a-3e. The specific storing operation is as described with reference to FIG. 5.

2.2 Intra-Machine Moving Loading/Auto Collecting Process

An intra-machine moving loading/auto collecting process is defined as an auto collecting function of, based on customer's setting, feeding the banknotes from the auto-designated banknote storage portion when the number of the banknotes accumulated in each of the respective storage portions 8b-8e becomes equal to or larger than a fixed accumulated banknote count, discriminating between the banknotes by the payment discriminating portion, tying up the banknotes into the bundles by the binding portion and storing the thus-obtained banknote bundles B in the banknote bundle storage portions, and also defined as an intra-machine moving loading function by which the customer himself or herself arbitrarily executes a process of tying up the banknotes in the banknote storage portions into the bundles by the bundle handling unit, corresponding to states of the respective storage portions and storing the banknote bundles in the banknote bundle storage unit 3.

Specifically, to begin with, in the loose banknote deposit/payment unit 103 illustrated in FIG. 9, the loose banknotes S in the storage portions 8b-8e, which have reached the banknote count designated by the customer, are, in the same way as in the case of 1.2 Bundle Collecting Process, accumulated in the stackers 76a, 76b and carried as the loose banknote bundles B′ by the carrying unit 6 to the bundle sorting payment unit 104.

Then, the loose banknote bundles B′ carried to the bundle sorting payment unit 104 shown in FIG. 5 are, in the same way as in the case of 2.1 Bundle Loading Process, fed out as the banknote bundles B to the ascending/descending path 2 and stored in the corresponding bundle storage portions 3a-3e.

Thus, it is possible not only to auto-collect the set number of banknotes in the storage unit but also to bundle the banknotes with the denomination designated corresponding to a state of the storage and store the banknote bundles in the bundle storage portion, wherein the handling itself is the same. In this case, the process is referred to as an intra-machine moving loading process, and a storage capacity of the storing unit can be ensured.

It is to be noted that if a plurality of temporary holding portions for bundling the banknotes is provided in the case of executing the process of tying up the loose banknotes in the process of tying up the first denomination of loose banknotes into the banknote bundles and ejecting these banknote bundles and in the process of tying up the second denomination of loose banknotes into the banknote bundles and storing these banknote bundles, the plurality of temporary holding portions is stored in distribution with both of the well-conditioned banknotes and the ill-conditioned banknotes on the basis of a discriminated result about the state of the banknotes by the discriminating portion, thereby enabling a distribution of the banknote states to be uniformized.

With this scheme, the banknote bundles containing only the well-conditioned banknotes or only the ill-conditioned banknotes can be prevented from being produced.

Moreover, the auto collecting function and the intra-machine moving loading function are carried out when reaching the customer's setting count in the description given above and may also be carried out when the respective storage portions get fully stored with the banknotes.

3. Process of Ejecting Stored Banknote Bundles Outside

3.1 Banknote Bundle Payment Process

A banknote bundle payment process is that the bundle sorting payment unit 104 pays the banknote bundles B (intra-machine banknote bundles) stored in the banknote bundle storage unit 3 and takes the banknote bundles B (as the eject banknote bundles) from the bundle payment port 10.

To be specific, the bundle sorting payment unit 104 illustrated in FIG. 5, at first, ejects the should-be-paid banknote bundles B to the carrying path C from the storage portions 3a-3e. A specific eject operation thereof is as described with reference to FIG. 7. The banknote bundles B ejected to the carrying path C are carried by the carrying unit 4 to the ascending/descending path 2 and placed on the ascending/descending stage 20 waiting there. Subsequently, the swing retreat portion 4a of the carrying unit 4 swings to the retreat position from the carrying position and thus retreats from within the ascending/descending path 2. Thereafter, the stage 20 rises to the payment position h2, and the shutter of the bundle payment port 10 opens, thereby taking the banknote bundles B out of the bundle payment port 10.

3.2 Banknote Bundle Out-of-Machine Ejection Port Collecting Process

A banknote bundle out-of-machine ejection port collecting process is a process sin which the bundle sorting payment unit 104 ejects the banknote bundles B (intra-machine banknote bundles) (as eject banknote bundles) stored in the banknote bundle storage unit 3 from the bundle out-of-machine ejection port 13 in order to collect the banknote bundles B.

Specifically, in the bundle sorting payment unit 104 shown in FIG. 5, to begin with, in the same way as in the case of 3.1 Banknote Bundle Payment Process, the should-be-collected banknote bundles B ejected from the storage portions 3a-3e are carried to the ascending/descending stage 20. Next, the stage 20 descends to a lower position h3, and, after the shutter of the bundle out-of-machine ejection port 13 has opened, the inclined plate 22 above the stage 20 gets tilted with the front being lowered, whereby the banknote bundle B is ejected from the bundle out-of-machine ejection port 13.

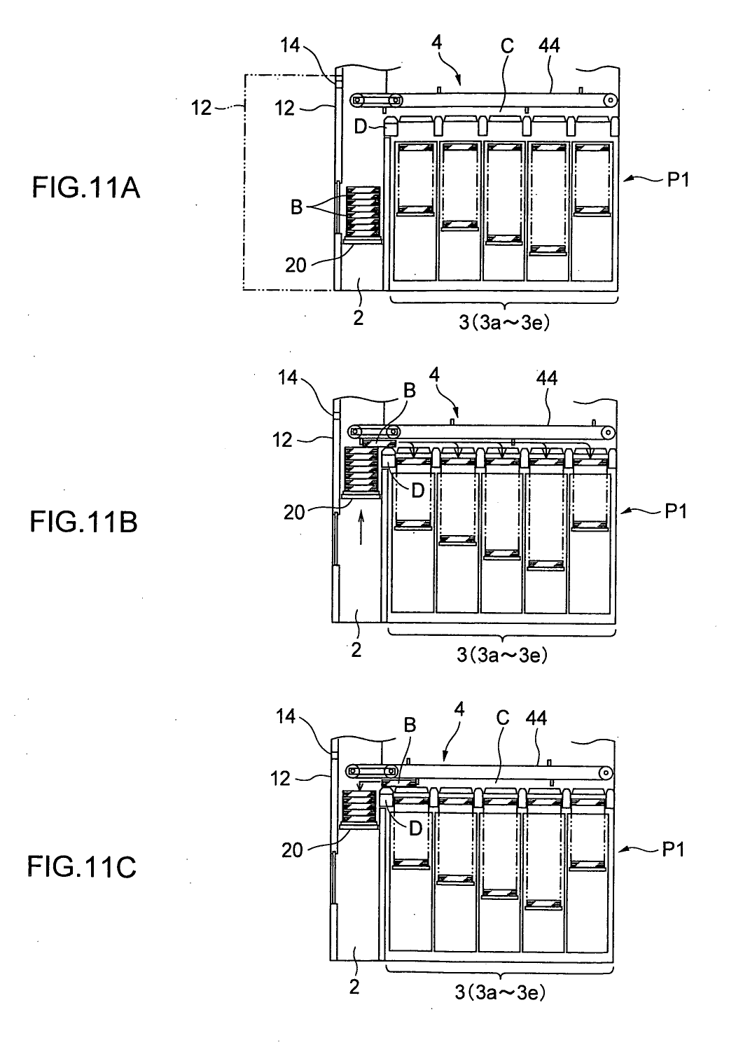

4. Out-of-Machine Bundle Loading Process (FIG. 11)

An out-of-machine bundle loading process is such a process that in the bundle sorting payment unit 104, the banknote bundles B (out-of-machine banknote bundles) inserted into the ascending/descending path 2 from the outside (via the opening/closing door 12) are automatically loaded (as storage banknote bundles) into the banknote bundle storage unit 3.

Specifically, when the operation unit 113 etc illustrated in FIG. 1 gives a predetermined loading instruction to the control unit, as shown in FIG. FIGS. 11A-11C, the process is executed in the following procedures. At first, the control unit automatically unlocks the locking device 14 of the opening/closing door 12 in the bundle sorting payment unit 104. The opening/closing door 12 opens, and, after the should-be-loaded banknote bundles B have been placed on the ascending/descending stage 20 waiting in the lower position h3 (FIG. 5) within the ascending/descending path 2, the opening/closing door 12 is closed (FIG. 11A).

Then, the control unit automatically locks the locking device 14 and starts auto-loading the inserted banknote bundles B (FIG. 11B). Namely, the stage 20 is raised on till the uppermost banknote bundle B reaches a height of the carrying path C, and this banknote bundle B is, in the same way as in the case of 2.1 Bundle Loading Process, loaded (stored) into the storage portions 3a-3e corresponding to the discriminated result of the bundle discriminating unit D. Thereafter, the respective banknote bundles B are similarly sequentially loaded while raising the stage 20 on a bundle-by-bundle basis.

In this case, the control unit sends the banknote bundles B undiscriminable to the bundle discriminating unit D when moved toward the storage unit 3 temporarily back toward the ascending/descending path 2 and then returns these banknote bundles B toward the storage unit 3 by use of the carrying unit 4, and, on this occasion, the banknote bundles B are again discriminated by the bundle discriminating unit D. This re-discriminating process may be done plural number of times according to the necessity.

Note that if the banknote bundles B moved by the carrying unit 4 toward the storage unit 3 are those disabled to be loaded into the storage unit 3, the control unit executes the following process. At the first onset, the carrying unit 4 returns the banknote bundles B onto the stage 20 of the ascending/descending path 2 (FIG. 11C). Then, a prompt of removing the banknote bundles B is displayed on the display screen 105a etc illustrated in FIG. 1.

This removal prompt display includes a display item enabled to specify a reason why the banknote bundles B can not be loaded into the storage unit 3. This reason is, it is considered, exemplified such as a reason (a) that the banknote bundles B are undiscriminable, a reason (b) that the bundle storage portions 3a-3e corresponding to the denomination of the banknote bundles B are already full of the banknote bundles, and a reason (c) that the bundle storage portions 3a-3e include none of setting of the storage portion corresponding to the denomination of the banknote bundles B.

These reasons are displayed in sentences or code numbers or symbols associated with these respective reasons on the display device.

The banknote bundles B can be automatically loaded into the storage unit 3 from outside by enabling the out-of-machine loading process to be executed. It is therefore possible to perform loading more accurately in a shorter period of time than in the case of manually loading the banknote bundles B. Further, the opening/closing door 12 can be automatically locked and unlocked by the locking device 14 when loading the banknote bundles B, and hence inconvenience caused when using a key can be obviated. Moreover, the stricter loading process can be executed by loading the banknote bundles B while the bundle discriminating unit D conducts the discriminating process. Further, the undiscriminable banknote bundles B are re-discriminated, thereby enabling a possibility of interrupting the auto loading process to be reduced by decreasing the number (occurrence frequency) of the banknote bundles B becoming undiscriminable to the end.

Moreover, in this out-of-machine loading process, if the banknote bundles B moved toward the storage unit 3 are those disabled to be loaded into the storage unit 3, the banknote bundles B are returned onto the stage 20 of the ascending/descending path 2, and the prompt for removing the banknote bundles B is displayed, thereby enabling the banknote bundles B to be immediately removed and the operation to be quickly get ready for resuming the loading process. On this occasion, the removal prompt display includes the display item enabled to specify the reason why the banknote bundles B can not be loaded into the storage unit 3, thereby making it possible to take a measure for preventing reoccurrence due to the same reason.

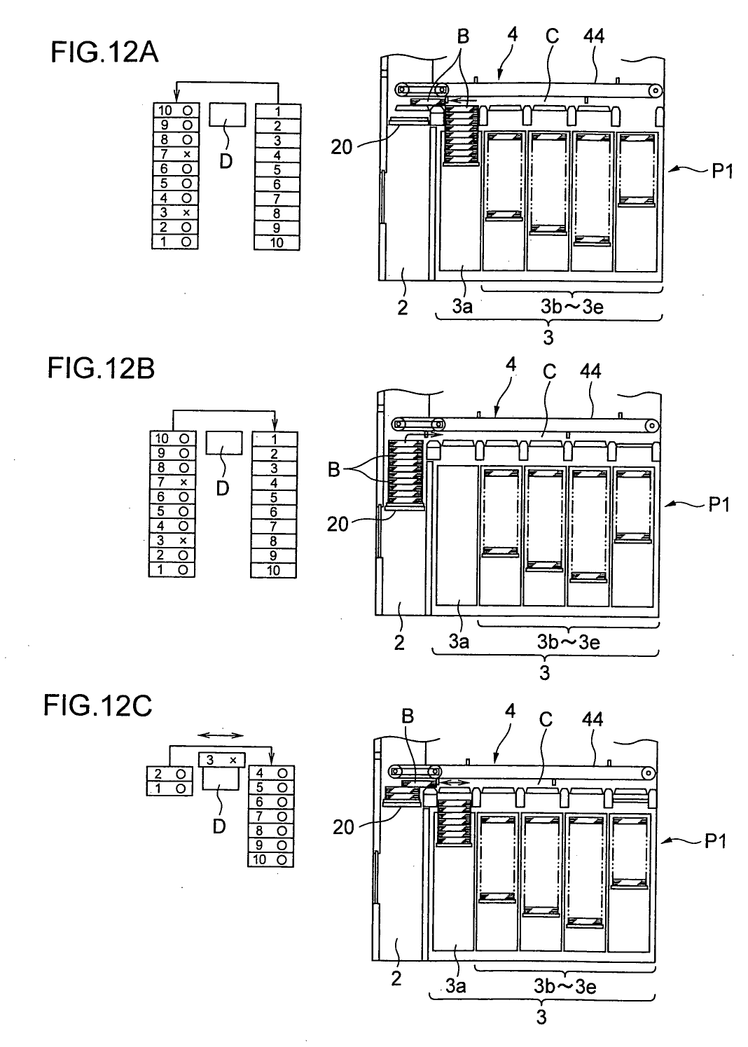

5. Auto Careful Inspection Process (FIG. 12)

An auto careful examination process is a process in which the bundle sorting payment unit 104 automatically carefully inspects the banknote bundles B (intra-machine banknote bundles) (an amount of intra-machine money is established by checking the denominations, the number of banknote bundles, etc.) stored in the banknote bundle storage unit 3.

Specifically, when the operation unit 113 etc illustrated in FIG. 1 gives an instruction for a predetermined careful inspection to the control unit, as shown in FIGS. 12A-12C, the control unit executes a process in the following procedures. To begin with, the banknote bundles B are ejected bundle by bundle from the target bundle storage portion (which is herein the bundle storage portion 3a according to the denomination), then carried toward the ascending/descending path 2 and accumulated onto the ascending/descending stage 20. At this time, the bundle discriminating unit D performs the first discriminating process about each of the banknote bundles B (FIG. 12A).

Next, the banknote bundles B accumulated onto the stage 20 are returned to the previous bundle storage portion 3a, and in the meantime the bundle discriminating unit D conducts the second discriminating process about only the banknote bundles B that have proven undiscriminable in the first discriminating process (FIG. 12B). In the illustrative example, the second discriminating process is carried out about only the third and seventh banknote bundles B with a mark (x) representing being undiscriminable in the first discriminating process, among the first through tenth banknote bundles B.

At this time, the banknote bundle B (which is the third banknote bundle in the illustrative example) proving undiscriminable even in the second discriminating process is temporarily carried back toward the ascending/descending path 2 by the carrying unit 4 and then returned toward the storage unit 3, and in the meantime the bundle discriminating unit D performs the third discriminating process (FIG. 12C). If disabled to be discriminated in the third discriminating process, this leads to a prompt of taking action through an alarm on a display screen 111 or 114 illustrated in FIG. 11 or both of these screens. Note that the third and fourth discriminating processes can be also executed when the banknote bundle B reciprocates.

In the auto careful inspection process, the banknote bundles B are, after being moved to the ascending/descending path 2 from the storage unit 3, returned to the storage unit 3 from the ascending/descending path 2, and in the meantime the careful inspection process is executed about the banknote bundle B on the basis of the discriminated result by the bundle discriminating unit D. Hence, the auto careful inspection process can be done without emptying any one of the bundle storage portions 3a-3e. It is therefore feasible to reduce the time required for the auto careful inspection process by highly efficiently performing the careful inspection process.

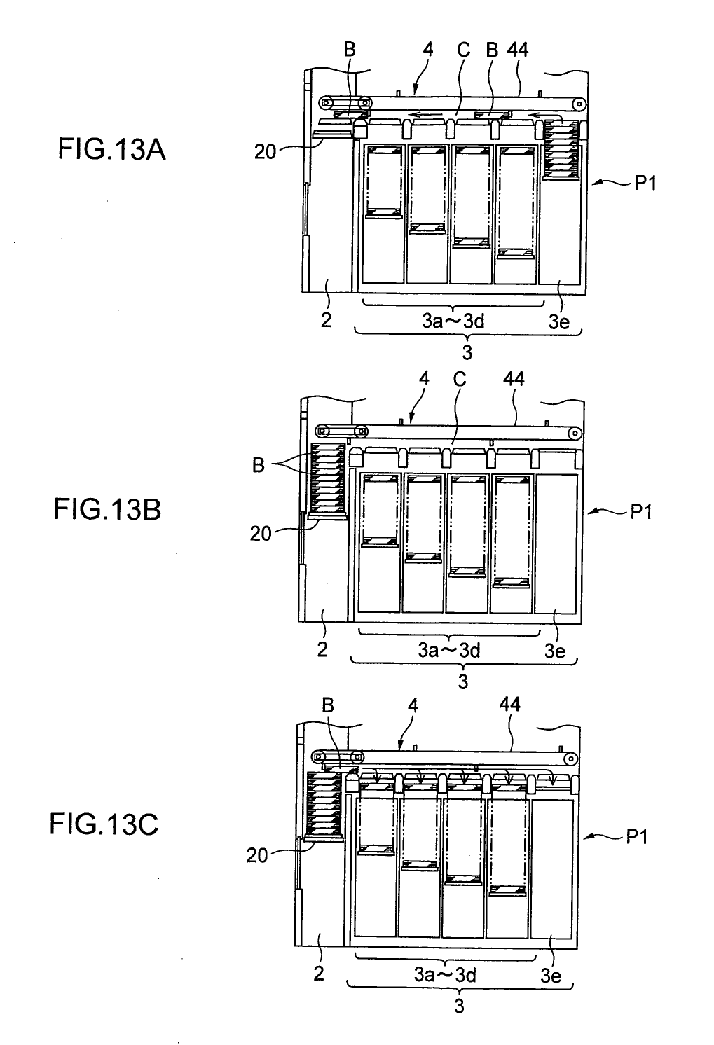

6. Auto Allocating Process (FIG. 13)

An auto allocating process is that the banknote bundles B stored in the denomination-mixed state in the batch manner storage portion 3e of the banknote bundle storage unit 3 of the bundle sorting payment unit 104, are automatically allocated to the bundle storage portions 3a-3e according to the corresponding denominations by use of the ascending/descending path 2.

To be specific, when the operation unit 113 etc illustrated in FIG. 1 gives a predetermined allocating instruction to the control unit, as shown in FIGS. 13A-13C, the control unit executes a process in the following procedures. At first, the banknote bundles B are ejected bundle by bundle from the batch manner storage portion 3e then carried toward the ascending/descending path 2 (FIG. 13A), and accumulated onto the ascending/descending stage 20 (FIG. 13B). After finishing moving all the banknote bundles B to the ascending/descending path 2, these banknote bundles B are returned on the bundle-by-bundle basis to the storage unit 3 and stored in the bundle storage portions 3a-3e according to the denominations corresponding to the discriminated results by the bundle discriminating unit D.

Note that this process may involve conducting the discriminating processes up to the third time similarly to the case of 5. Auto Careful Inspection Process, however, the discriminating process corresponding to second or third time among these processes may also be omitted.

In the auto careful inspection process, the banknote bundles B stored in the batch manner storage portion 3e are, after being moved to the ascending/descending path 2, allocated to the bundle storage portions 3a-3d according to the denominations from the ascending/descending path 2. Hence, the banknote bundles B to be allocated are, if corresponding to the already-fully-stored bundle storage portions 3a-3d according to the denominations or even if corresponding to none of the bundle storage portions 3a-3d according to the denominations, returned again to the batch manner storage portion 3e, whereby the allocating process can continue. Therefore, the process of allocating the banknote bundles to the bundle storage portions 3a-3d according to the denominations from the batch manner storage portion 3e can be smoothly executed.

Further, in (5) Auto Careful Inspection Process and (6) Auto allocating Process, the discriminating process up to the second time is executed during one reciprocation of the banknote bundles B between the storage unit 3 and the ascending/descending path 2, thereby enabling the auto careful inspection process and the auto allocating process to be executed at the higher efficiency. Moreover, the number (occurrence frequency) of the banknote bundles B becoming undiscriminable to the end can be reduced by further performing the third discriminating process according to the necessity.

B. Coin Handling Unit

As described above, the coin deposit/payment sorting machine that executes the coin-oriented process is, as illustrated in FIG. 1, constructed of the loose coin deposit/payment unit 102 and the packaged coin payment unit 101.

An upper part of the loose coin deposit/payment unit 102 is formed with a coin insertion port 121. Normally, a shutter of the coin insertion port 121 remains closed but gets opened when inserting the loose coins, and the hopper 201 gets exposed. A right lower side of the coin insertion port 121 is formed with a reject port 122 into which the coins rejected when deposited are returned. Further, a calculation chute 123 into which the counted coins are ejected is formed at a central part of the front panel. The calculation chute 123 is used for an in-bag process of simply counting the coins and putting the coins into a bag. Moreover, a return box 124 receiving the loose coins to be returned is installed on the left side of the front panel.

On the other hand, the packaged coin payment unit 101 is provided at its upper part with a wrapped coin payment port 125. Provided at a middle stage thereof are a wrapped coin batch manner storage box 127 for storing batch manner the wrapped coins disabled to be stored in the storage portions according to the denominations and a loose coin payment box 129 for paying the loose coins. A wrapped coin ejection port 126 from which to eject the wrapped coins when in the collecting process is formed in a lower part of the front panel. An out-of-machine fraction box 128 into which the coins rejected when wrapped are thrown, is provide at the lower end part at the center.

The respective units will hereinafter be described.

(1) Loose Coin Deposit/Payment Unit 102

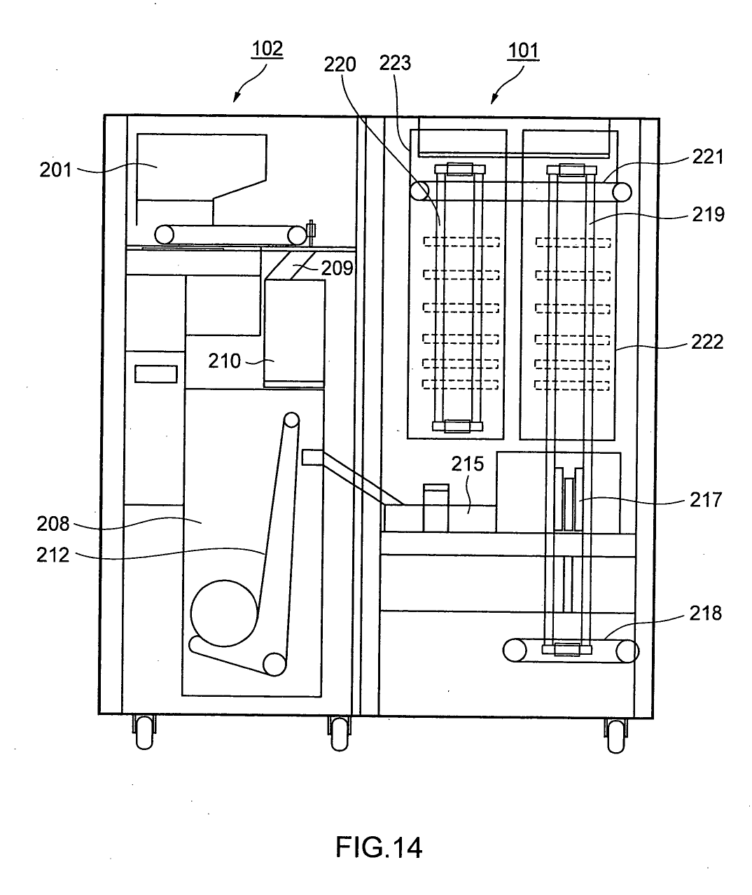

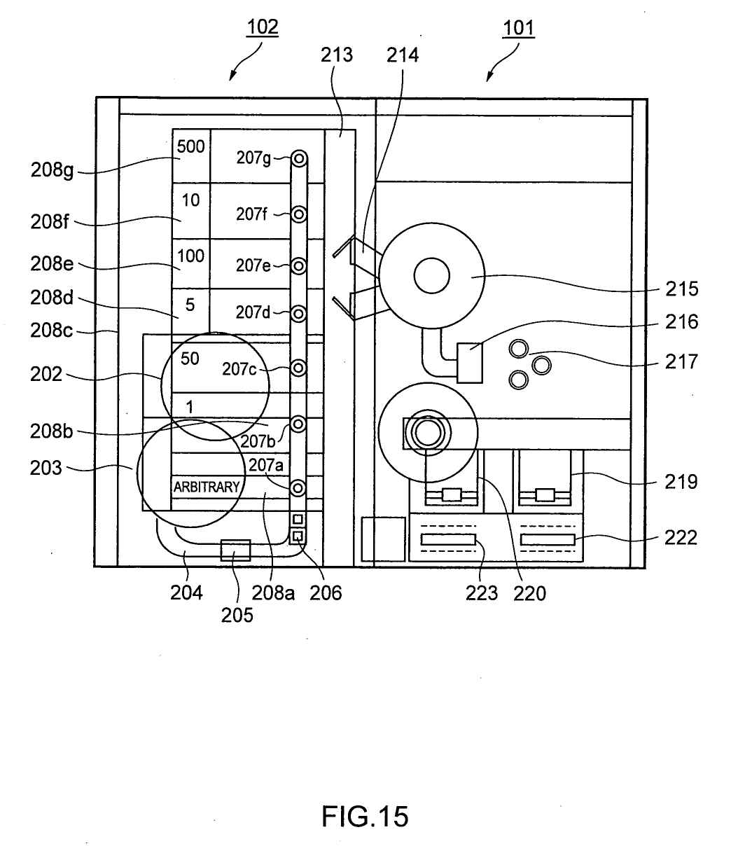

FIG. 14 is a vertical sectional view schematically illustrating an internal structure of the coin handling unit in FIG. 1. FIG. 15 is a plan view schematically showing a main configuration in FIG. 14.

The coins put into the coin input hopper 201 are sent one by one to a path 204 by a supply disc 202 existing on a bottom face of the hopper 201 and by a rotary disc 203 supplied with the coins by predetermined quantities through rotations of the supply disc 202.

The path 204 is provided with a discriminating portion 205 that specifies the type of the coin from a material, a size and a pattern on the surface. Provided in the path 204 ahead of the discriminating portion 205 are a reject selecting portion 206 for rejecting contaminated/unfit coins etc, and denomination selecting portions 207a through 207g that drop down the coins coming under the denominations concerned on the basis of diameters of apertures thereof. The coins passing through the denomination selecting portions 207a-207g are accumulated in temporary holding portions 210 provided for the respective denomination selecting portions via a chute 209 serving as a guide member. Bottoms of the temporary holding portions 210 are opened, whereby the coins are stored in coin storage portions 208a-208g. Herein, the symbol ‘a’ represents the arbitrary denomination selecting portion (and the arbitrary coin storage portion), while the symbols ‘b’ through ‘g’ represent the denomination selecting portions and the coin storage portions, which are provided, in the case of the coins circulated in Japan, in the sequence from the smallest diameter such as 1 yen, 50 yen, 5 yen, 100 yen, 10 yen and 500 yen. As for the arbitrary selecting portion (and the arbitrary coin storage portion), it is possible to set the overflow coins, the direct-wrapping-oriented coins and the bag-input-oriented coins of the denominations, which can not be stored in the temporary holding portions and the coin storage feeding portions.

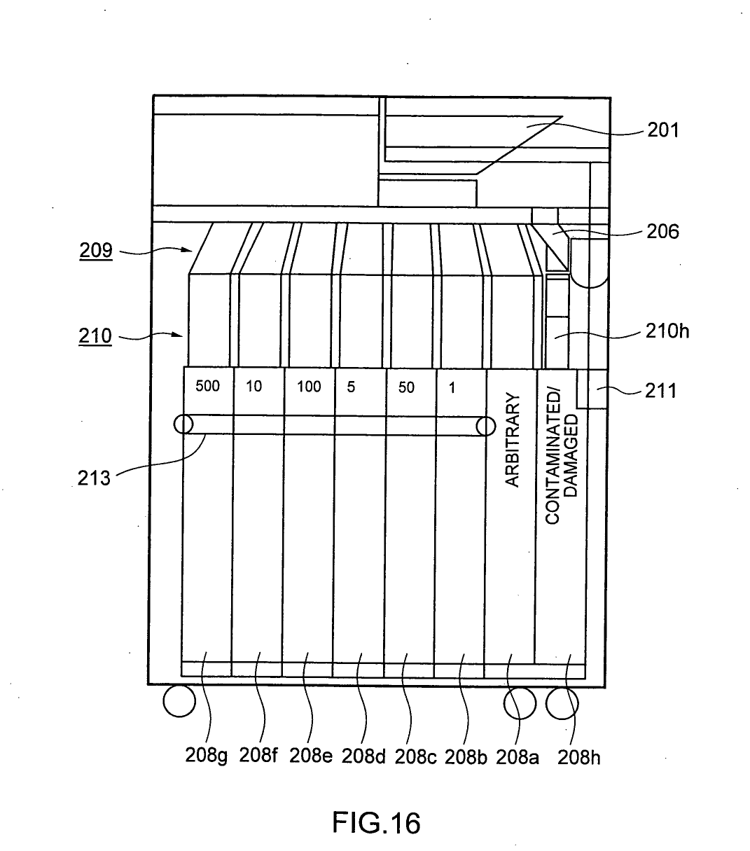

FIG. 16 is a side view showing a layout of these coin storage portions. As apparent from FIG. 16, a reject storage portion 208h is provided for the contaminated/unfit coins as well. It is to be noted that the coins rejected by the reject selecting portion 206 can be output into the reject port 122 by switching over the route.

The coins stored in the respective coin storage portions 208 are taken out by a takeout mechanism 212 using the belt shown in FIG. 13, and are placed on a belt carrying path 213 movable in forward/backward directions.

(2) Wrapped Coin Payment Unit 101

The coins on the belt carrying path 213 of the loose coin deposit/payment unit 102 are guided onto a rotary disc 215 for wrapping the coins by a take-in mechanism 214 having two guides and then accumulated in an accumulating portion 216 through rotations of the rotary disc 215. After a predetermined number of coins have been accumulated in the accumulating portion 216, the coins are wrapped by a coin wrapping portion 217. The coin wrapping portion 217 is, as known well, constructed such that a predetermined number of stacked coins are pushed up to a predetermined wrapping position by a support rod protruding upward and rotated by three pieces of wrapping rollers while nipping peripheral surfaces of the stacked coins, then a sheet of wrapping paper (not illustrated) is wound around peripheries of the stacked coins by wrapping the wrapping paper along the peripheral surfaces of the stacked coins, and the edge of the wrapping paper is caulked to the edge surfaces of the stacked coins, thus obtaining the wrapped coins (a bar of coins).

The wrapped coins are carried by a belt carrying mechanism 218 to a first elevator 219. The first elevator 219 rises to carry the wrapped coins, hereby the wrapped coins are stored in a proper storage portion of first wrapped coin storage portions 222 provided upward. Second wrapped coin storage portions 223 are provided in parallel with the first wrapped coin storage portions 222. Similarly, a second elevator 220 is provided for moving the wrapped coins up and down. Further, a belt carrying mechanism 221 is provided for moving the wrapped coins in the horizontal direction between the first elevator 219 and the second elevator 220, thereby increasing a storage capacity with a narrow space. Moreover, the wrapped coins are controlled to be stored alternately in the wrapped coin storage portions 222, 223 by use of the belt carrying mechanism 221 or stored in the wrapped coin storage portions having a less storage quantity, thus enabling the wrapped coins to be stored evenly in distribution.

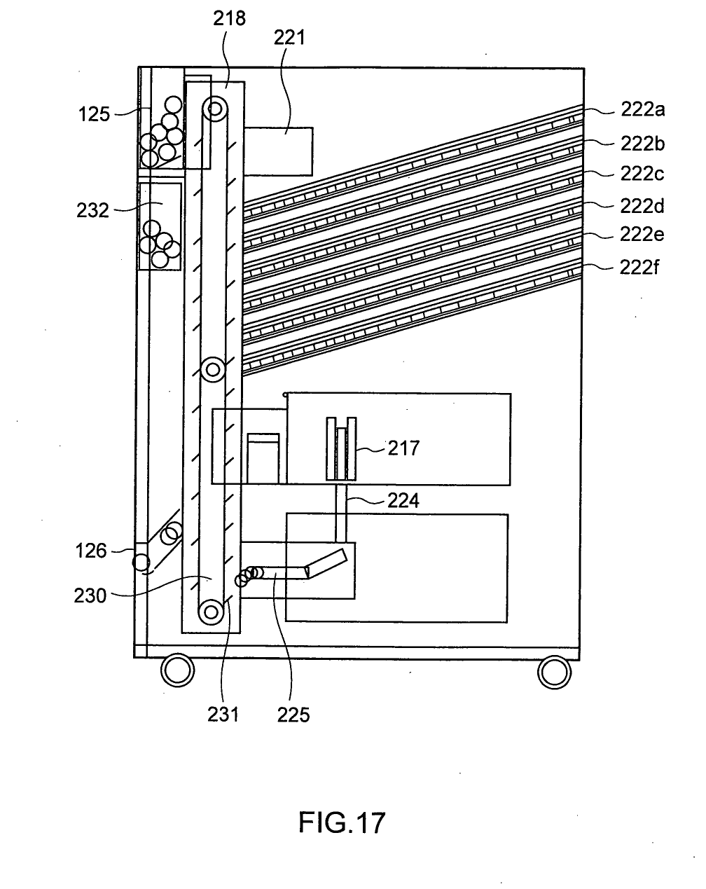

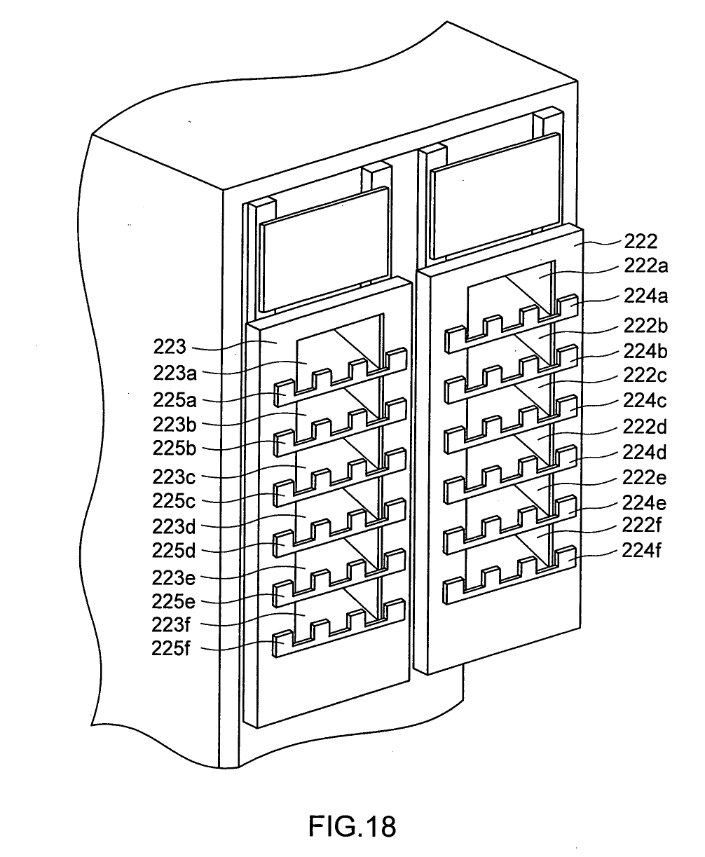

FIG. 17 is a side view of the main configuration related to storing the wrapped coins, as viewed from a right side surface in FIG. 14. FIG. 18 is a perspective view showing one example of the wrapped coin storage portions 222, 223. Herein, each of the wrapped coin storage portions 222, 223 has six sections (bar-of-wrapped coins trays) attached with suffixes ‘a’-‘f’.

As described above, the coins are wrapped by the coin wrapping portion 217, however, the post-wrapping coins are set vertical in a longitudinal direction, i.e., in a stacking direction and therefore hard to deal with. Hence, the wrapped coins are dropped by use of the first chute 224, at which time the longitudinal direction of the wrapped coins is invariably parallel with the front surface of the main body, and the second chute 225 is formed so that the wrapped coins get rolling to the front of the elevator while changing the longitudinal direction to the horizontal direction.

A belt 230 partly constituting the elevator 218 is driven by a motor (not illustrated) and stretched between upper and lower rotatable pulleys. Fins 231 having an angle directed upward and building up a placing portion are embedded at fixed intervals in the surface of the belt 230. The wrapped coins are mounted one by one on the fins and raised while being driven by the elevator.

The wrapped coin storage portions 222, 223 provided at the upper part include storage-oriented inclined plates 222a-222f, 223a-223f installed at substantially the same angle as that of each fin 231. Stopper plates 224a-224f, 225a-225f having notched portions are provided on the inlet side thereof. For moving the wrapped coins to the inclined plates 222a-222f from the fins 231 of the elevator, the wrapped coins may be moved onto the inclined plates over the stopper plates from the fin portion by use of a take-in/take-out member having such a shape as to enable its front end to pass through the notched portion.

Note that the wrapped coins are moved onto the fins of the elevator by slightly raising the take-in/take-out member inserted into the notched portion when taking the wrapped coins out of the wrapped coin storage portion as when outputting the wrapped coins. Then, the wrapped coins get gravity-dropped when passing by the maximum point, and hence the wrapped coin payment port 125 (see FIG. 16) is provided at this position. It is therefore possible to take the wrapped coins from the wrapped coin payment port 125.

Moreover, a vertically-movable box 232 into which the wrapped coins are put, whereby the wrapped coins to be output can be stored therein. This output box can be cassettized, and can be also exchanged by opening the front door and taking out the box as the necessity may arise. Further, an output port 126 (see FIG. 1) via which to output the wrapped coins outside the machine on a single coin-bar basis according to the necessity, is provided at the lower part of the front panel.

Next, handling contents, based on the configurations described above, in the coin handling units 103, 104 according to the present embodiment will be explained with reference to FIGS. 14-18. These processes are executed based on the inputs from the operation unit 113 illustrated in FIG. 1 under the control of the control unit, and the handling contents are displayed on the display screen 111 as the necessity may arise.

7. Process Related to Input of Loose Coins into Loose Coin Input Port

7.1 Loose Coin Deposit Process

When setting the loose coins into the hopper 201 shown in FIG. 14 by opening the shutter 121 shown in FIG. 1, the coins are sent as the supply disc 202 rotates and fed out one by one to the coin path 204 and then carried along this coin path. The discriminating portion 205 provided midways of the coin path 204 discriminates between the coins about the fit/unfit states, the denominations, etc. The reject selecting portion 206 for rejecting the contaminated/unfit coins etc rejects the contaminated/unfit coins, and the rejected coins are, after being temporarily reserved in a temporary holding portion 210h, discharged from the reject port 122. In this case, such a scheme can be also set that the coins are accumulated in a coin storage portion 208h under the temporary holding portion 210h by switching over the route. Moreover, the fit (normal) coins passing through the denomination selecting portions 207a-207g are accumulated in the temporary holding portions 210 provided for the respective denomination selecting portions via the chute 209 serving as the guide member. The coins are, when the bottoms of these temporary holding portions are opened, stored in the coin storage portions 208a-208g.

7.2 Loose Coin Loading Process

A loose coin loading process, which is similar to 7.1 Loose Coin Deposit Process, is that the fit (normal) coins are likewise stored in the coin storage portions via the denomination selecting portions. If determined to be the unfit coins by the reject selecting portion 206, however, the unfit coins are discharged directly into the reject port 122 without via the temporary holding portion 210h by switching over the chute direction.

7.3 Coin Wrapping Loading Process

A coin wrapping loading process is, similarly to 7.1 Loose Coin Deposit Process, that the loose coins set in the hopper 201 are taken in, then discriminated by the coin discriminating portion 205 and placed on the belt carrying path 213 movable in the forward/backward directions. The coins on the belt carrying path 213 are guided by the take-in mechanism 214 having the two guides onto the rotary disc 215 for wrapping the coins. With the rotations of the rotary disc 215, the coins are accumulated in the accumulating portion 216. A predetermined number of coins are, after being accumulated in the accumulating portion 216, wrapped by use of the three wrapping rollers in the coin wrapping portion 217. Then, the wrapped coins are sent to the first elevator 219 by the belt carrying mechanism 218. The wrapped coins are raised and thus carried by the first elevator 219 and are, just over the maximum point, stored in the wrapped coin batch manner storage box 232.

7.4 Sorting Process

In 7.1 Loose Coin Deposit Process, the coins placed on the belt carrying path 213 movable in the forward/backward directions are guided onto the rotary disc 215 for wrapping the coins by the take-in mechanism 214 having the two guides and accumulated in the accumulating unit 216 through the rotations of the rotary disc 215. The predetermined number of coins are, after being accumulated in the accumulating unit 216, wrapped by use of the three wrapping rollers in the coin wrapping portion 217.

The wrapped coins are sent to the first elevator 219 by the belt carrying mechanism 218. Then, the wrapped coins are raised and thus carried by the first elevator 219 and are, just over the maximum point, discharged to the wrapped coin payment port 126, thus enabling the wrapped coins to be taken out.

7.5 In-Bag Process

An in-bag process is, similarly to 7.1 Loose Coin Deposit Process, that the loose coins set in the hopper 201 are taken in, then counted and output from a calculation chute 123 provided at the central part of the front panel. This process intends to check the number of coins already proven to be the fit (normal) coins, however, the discriminating process is conducted for eliminating the contaminated/unfit coins. The contamination/unfitetection can involve setting [ON] and [OFF]. In the case of setting [ON], based on the discriminated result, the contaminated/unfit coins are rejected, while the fit coins (normal coins) are put in a storage bag set in the calculation chute 123, whereby the in-bag coins convenient for portability within the financial institution can be obtained (the in-bag process can be executed).

On the other hand, in the case setting [OFF], both of the fit coins and the contaminated/unfit coins are taken as the in-bag coins by setting the storage bags in the calculation chute 123.

8. Process Related to Feed-Out from Loose Coin Storage Portion

8.1 Loose Coin Payment Process

When the control unit gives a loose coin paying instruction, a necessary number of coins of the designated denomination, which are stored in the coin storage portions 208a-208g, are taken out by the takeout mechanism 212, and discharged to the loose coin payment box 129 illustrated in FIG. 1 via the carrying path (not illustrated), carrying box, etc, and the desired coins are thus obtained from the loose coin payment box 129.

8.2 Loose Coin Auto Collecting Process/Intra-Machine Moving Loading Process

A loose coin auto collecting process is a process executed when any one of the coin storage portions 208a-208g reaches the coin count set by the customer and when a residual quantity in the wrapped coin storage portion becomes small. The loose coin auto collecting process is a process of feeding the loose coins from the coin storage portion, then wrapping the loose coins by the coin wrapping portion 217, carrying the wrapped coins by use of the elevator 219 etc, and storing the wrapped coins in an output-oriented cassette 222. The cassette 222 is taken out by pulling out the front panel of a wrapped coin processor 102.

This process can be performed, without being limited to when reaching the coin count set by the customer, similarly based on the instruction. In this case, the coins are simply moved within the machine, which is therefore referred to as an intra-machine moving loading process.

Moreover, the auto collection can be also conducted when the coin storage portions get full of the coins irrespective of the setting.

8.3 Loose Coin Pack Collecting Process

A loose coin pack collecting process is the same as 8.2 Loose Coin Auto Collecting Process/Intra-Machine Moving Loading Process in terms of such a point that the loose coins are fed out of any designated storage portion among the coin storage portions 208a-208g, then wrapped by the coin wrapping portion 217, and the wrapped coins are carried by use of the elevator 219 etc. The loose coin pack collecting process is, however, different from 8.2 Process in terms of a point that the wrapped coins are ejected from the wrapped coin ejection port 126 via an out-of-machine chute.

8.4 Loose Coin Denomination-Based Storage Portion Collecting Process

A loose coin denomination-based storage portion collecting process is a process, wherein the loose coins are fed out of the coin storage portion of the designated denomination among the coin storage portions 208a-208g and discharge into the payment reject box.

9. Process Related to Feed-Out From Wrapped Coin Batch Manner Storage Box

9.1 Wrapped Coin Payment Process

A wrapped coin payment process is a process of feeding out a designated number of wrapped coins of a designated denomination from the wrapped coin storage portions 222, 223 and discharging the wrapped coins into the wrapped coin payment port 125.

9.2 Wrapped Coin Ejection Port Collecting Process

A wrapped coin ejection port collecting process is a process of feeding out a designated number of wrapped coins of a designated denomination from the wrapped coin storage portions 222, 223 and ejecting the wrapped coins outside the machine from the wrapped coin ejection port 126.

9.3 Wrapped coin Payment Port Collecting Process

A wrapped coin payment port collecting process is a process of feeding out a designated number of wrapped coins of a designated denomination from the wrapped coin storage portions 222, 223 and discharging the wrapped coins into the wrapped coin payment port 125.

In addition to the processes described above, the banknote and coin handling system according to the present invention enables the manual direct takeout. Namely, the necessary doors are formed to enable the batch manner takeout from the batch manner storage portion, the batch manner takeout from the bundled banknote cassette, the batch manner takeout from the wrapped coin batch manner storage box and also the single takeout of the wrapped coins.

The embodiment discussed above has exemplified nothing but one example of each of the configurations of the respective portions, and the scope of the present invention embraces changes, modifications, replacements with substituting units, and enlargement or contraction, which are carried out in the range of normal knowledge of those skilled in the art.

For example, normally the coin storage portions are provided by the number corresponding to the number of types of the circulated coins, however, this scheme is not necessarily attained. Namely, if a sufficient number of coin storage portions can not be provided in terms of the size, a configuration is that the coins may be stored in the mixed state of the denominations and may be selected according to the denominations when paying and wrapping the coins. Moreover, the two or more coin storage portions can be allocated to the coins of which the usage frequency is high.

As for the processes about the coins described above, the storage portions can be provided corresponding to the denominations of the coins circulating in the respective countries, e.g., the six existing denominations such as 1 dollar, 50 cents, 25 cents, 10 cents, 5 cents and 1 cent in the U.S.A. and the six existing denominations such as 1 yuan, 5 jao, 1 jao, 5 fen, 2 fen and 1 fen in China. As a matter of fact, however, the three denominations of 5 fen, 2 fen and 1 fen each have a small quantity of circulation in China, and hence these currencies may not wrapped according to the denominations but may be received in a loose state.

The banknote and coin handling system described above is one example, and, the banknote and coin handling system according to the present invention may be any type of system if having the configuration of combining together the apparatus dealing with the banknotes and the apparatus dealing with the coins. For example, the right-and-left positions of the loose coin deposit/payment unit 102 and the wrapped coin payment unit 101 may be reversed.

Further, the banknote and coin handling system described above has, basically, the combination of the four units such as the loose banknote deposit/payment unit and the bundle sorting payment unit that execute the process related to the banknotes, and the loose coin deposit/payment unit and the wrapped coin payment unit that execute the process related to the coins. A banknote deposit/payment sorting machine having the same function related to the banknotes may be combined with a coin deposit/payment sorting machine, or apparatuses having further sub-functions may also be combined.

What is claimed is:

1. A banknote and coin handling system for handling banknotes and coins, comprising:
banknote handling equipment that processes the banknotes; and
coin handling equipment that processes the coins, wherein loose banknotes inputted from outside a machine can be paid or stored in any designated form, a form of loose banknotes or a form of bundled banknotes, and
loose coins inputted from outside said machine can be paid or stored within said machine in any designated form, a form of loose coins or a form of wrapped coins.

2. A banknote and coin handling system according to claim 1, wherein said banknote handling equipment includes at least: a banknote discriminating portion that discriminates between the inputted loose banknotes; banknote storage portions provided according to a plurality of denominations and stored with the loose banknotes based on a discriminated result of said banknote discriminating portion; a bundle handling portion that bundles a predetermined number of banknotes taken out of said banknote storage portions; and banknote bundle storage portions stored with the bundle banknotes, and
said coin handling equipment includes at least: a coin discriminating portion that discriminates between the inputted loose coins; coin storage portions provided according to a plurality of denominations and stored with the loose coins based on a discriminated result of said coin discriminating portion; a coin wrapping portion that packs a predetermined number of coins taken out of said coin storage portions; and wrapped coin storage portions.

3. A banknote and coin handling system according to claim 2, wherein said banknote handling equipment is constructed of a loose banknote deposit/payment unit into and from which the loose banknotes are deposited and paid, a bundle sorting payment unit that bundles and pays the loose banknotes deposited into said loose banknote deposit/payment unit and pays the bundled banknotes, and a banknote bundle payment unit that pays the banknote bundle from said bundle sorting payment unit, and
said coin handling equipment is constructed of a loose coin deposit/payment unit into and from which the loose coins are deposited and paid, and a wrapped coin payment unit that packs the loose coins deposited into said loose coin deposit/payment unit and pays the thus-wrapped coins or pays the wrapped coins directly from said wrapped coin storage portion.

4. A banknote and coin handling system according to claim 3, wherein said loose banknote deposit/payment unit, said bundle sorting payment unit, said loose coin deposit/payment unit and said wrapped coin payment unit are so combined as to have at least the same height.

5. A banknote and coin handling system according to claim 4, wherein a new banknote payment unit that pays pre-stored new banknotes in response to a request is further combined.

6. A banknote and coin handling system for handling banknotes and coins, comprising:
a banknote deposit/payment sorting machine including: a banknote input port receiving an input of loose banknotes; a discriminating portion that discriminates between the banknotes taken in from said banknote input port about authenticity, fitness, a front side or back side and denominations; a payment discriminating portion that discriminates between payment target banknotes about the denominations; a bundle discriminating portion that discriminates between the banknote bundles about the denominations; a banknote inverting portion that inverts the banknotes; temporary holding portions according to the denominations; a batch manner temporary holding portion; a plurality of banknote storage portions that store the banknotes; a bundle handling unit that bundles a predetermined number of banknotes; a loose banknote payment port; a banknote bundle payment port; a reject port; a batch manner storage portion that stores batch manner the loose banknotes and unfit banknotes; a banknote bundle storage portion; and a bundle out-of-machine ejection port, and
a coin deposit/payment sorting machine including: a loose coin input port into which the loose coins are inputted; a coin discriminating portion that discriminates between the handling target coins about authenticity, fitness and denominations; coin temporary holding portions according to the denominations; a coin batch manner temporary holding portion that reserves batch manner the coins irrespective of the denominations; coin storage portions that store the coins according to the denominations; a coin wrapping portion that accumulates and packs a predetermined number of coins; a loose coin payment box; a wrapped coin output port; a wrapped coin payment port; wrapped coin storage portions; a bag storage oriented output port; a reject port; a return box; an out-of-machine fraction box; wrapped coin storage portions,
wherein among at least:
(1) a process of storing the lose banknotes inputted into said banknote output port in said banknote storage portions;
(2) a process of tying up the loose banknotes inputted into said banknote input port or the loose banknotes stored in said banknote storage portions into banknote bundles by said bundle handling unit, and outputting the banknote bundles outside said machine;
(3) a process of tying up the loose banknotes inputted into said banknote input port or the loose banknotes stored ins aid banknote storage portions into banknote bundles and storing the banknote bundles in said banknote bundle storage portions;
(4) a process of outputting the banknote bundles stored in said banknote deposit/payment sorting machine outside said machine;
(5) a process of storing said coin storage portions with the loose coins output into said loose coin input port;
(6) a process of wrapping the loose coins inputted into said lose coin input port or the loose coins stored in said coin storage portions and outputting the wrapped coins to the outside;
(7) a process of wrapping the loose coins inputted into said lose coins input port and storing the wrapped coins in said wrapped coin storage portions or said wrapped coin batch manner storage box;
(8) a process of outputting the wrapped coins stored in said wrapped coin storage portions to the outside of said machine; and
(9) a process of outputting the loose coins stored in said coin storage portions to the outside in an as-is state,
arbitrary functions can be set.

7. A banknote and coin handling system according to claim 6, wherein said banknote deposit/payment sorting machine and said coin deposit/payment sorting machine are combined so as to have at least the same height.

8. A banknote and coin handling system according to claim 7, wherein a new banknote payment unit paying pre-stored new banknotes in response to an instruction is further combined.

9. A banknote and coin handling system for handling banknotes and coins comprising:
a banknote deposit/payment sorting machine;
a coin deposit/payment sorting machine combined with said banknote deposit/payment sorting machine;
an operation unit;
a display unit; and
a control unit,
said banknote deposit/payment sorting machine including, as a range of components,: a banknote input port receiving an input of loose banknotes; a discriminating portion that discriminates between the banknotes taken in from said banknote input port about authenticity, fitness, a front side or back side and denominations; a payment discriminating portion that discriminates between payment target banknotes about the denominations; a bundle discriminating portion that discriminates between the banknote bundles about the denominations; a banknote inverting portion that inverts the banknotes; temporary holding portions according to the denominations; a batch manner temporary holding portion; a plurality of banknote storage portions that store the banknotes; a bundle handling unit that bundles a predetermined number of banknotes; a loose banknote payment port; a banknote bundle payment port; a reject port; a batch manner storage portion that stores batch manner the loose banknotes and unfit banknotes; a banknote bundle storage portion; and a bundle out-of-machine ejection port,
said banknote deposit/payment having the following functions such as:
(1) a loose banknote deposit function of taking in the banknotes set in said banknote input port, discriminating between the banknotes by said discriminating portion, rearranging the front side and the back side of the banknote by said banknote inverting portion as the necessity may arise, accumulating fit banknotes in said temporary holding portions or accumulating unfit banknotes in said batch manner reserving portion, storing the fit banknotes in said banknote storage portions or storing the unfit banknotes in said batch manner storage portion, and returning the undiscriminable banknotes and the extremely contaminated banknotes disabled to be treated as the banknotes to said reject port;
(2) a loose banknote input port loading function of taking in the banknotes set in said banknote input port, discriminating between the banknotes by said discriminating portion, rearranging the front side and the back side of the banknote by said banknote inverting portion as the necessity may arise, storing the fit banknotes in said banknote storage portions after being accumulated in said temporary holding portions, and returning the unfit banknotes directly to said reject port;
(3) a loose banknote batch manner storage portion loading function of feeding out the loose banknotes from said batch manner storage portion, discriminating between the banknotes by said discriminating portion, storing the fit banknotes in said banknote storage portions after being accumulated in said temporary holding portions, and returning the unfit banknotes directly to said reject port;
(4) a sorting function of feeding out the banknotes set in said banknote input port, discriminating between the banknotes by said discriminating portion, rearranging the front side and the back side of the banknote by said banknote inverting portion as the necessity may arise, bundling the banknotes of a designated denomination by said bundle handling unit and outputting the bundled banknotes to the outside of said machine from said bundle out-of-machine output port, and returning the banknotes of denominations other than the designated denomination after being accumulated in said temporary holding portions;
(5) a batch manner storage portion sorting function of feeding out the banknotes from said batch manner storage portion, bundling the banknotes of the designated denomination by said bundle handling unit on the basis of a discriminated result of said discriminating portion and outputting said bundled banknotes to the outside of said machine, and returning the banknotes of the denominations other than the designated denomination after being stored in said temporary holding potions corresponding to the denominations;
(6) a loose banknote payment function of feeding out a designated number of banknotes of a designated denomination from said corresponding banknote storage portion, discriminating between the banknotes by said payment discriminating portion and thereafter outputting the banknotes to said loose banknote payment port;
(7) a loose banknote batch manner storage portion collecting function of feeding out the designated number of banknotes of the designated denomination from said corresponding banknote storage portion, discriminating between the banknotes by said payment discriminating portion and thereafter storing the banknotes in said batch manner storage portion;
(8) a loose banknote bundle collecting function of feeding out the designated number of banknotes of the designated denomination from said corresponding banknote storage portion, bundling the banknotes by said bundling portion after discriminating between the banknotes by said payment discriminating portion, and outputting the bundled banknotes to the outside of said machine;
(9) an unfit banknote bundle collecting function of feeding out the unfit banknotes if the unfit banknotes are stored in said batch manner storage portion, discriminating between the banknotes about the denominations by said discriminating portion, bundling the banknotes of a plurality of specified denominations by said bundle handling unit, and returning the banknotes of other unspecified denominations;
(10) an auto collecting function of automatically feeding out the banknotes, if an accumulation count of each of said storage portions becomes equal to larger than fixed count, from said designated banknote storage portion on the basis of a customer's setting, discriminating between the banknotes by said payment discriminating portion, bundling the banknotes by said bundling portion and storing the thus-obtained bundled banknotes in said banknote bundle storage portion, and an intra-machine moving loading function by which a customer himself or herself arbitrarily executes a process of getting the banknotes in said banknote storage portion bundled by said bundle handling unit in accordance with a state of each of said storage portions, and storing the bundled banknotes in said banknote bundle storage portion;
(11) a banknote bundle input port loading function of taking in the loose banknotes set in said banknote input port, discriminating between the banknotes by said discriminating portion, rearranging the front side and the back side of the banknote by said banknote inverting portion as the necessity may arise, bundling the banknotes of the designated denomination by said bundle handling unit, storing the bundled banknotes in said banknote bundle storage portion, and returning the banknotes of the denominations other than the designated denomination to said reject port;
(12) a banknote bundle storage portion loading function of feeding out the loose banknotes stored in said batch manner storage portion, discriminating between the banknotes by said discriminating portion, rearranging the front side and the back side of the banknote by said banknote inverting portion as the necessity may arise, bundling the banknotes of the designated denomination by said bundle handling unit, storing the bundled banknotes in said banknote bundle storage portion, and returning the banknotes of the denominations other than the designated denomination to said reject port;
(13) a banknote bundle out-of-machine loading function of taking in the loading-oriented bundled banknotes set in said bundled banknote payment port, discriminating between the bundled banknotes about the denominations by said bundle discriminating portion, and storing the banknotes of the denomination concerned in a bundled banknote cassette;
(14) a banknote bundle payment function of feeding out the bundled banknotes from said designated bundled banknote cassette, discriminating between the bundled banknotes about the denominations by said bundle discriminating portion, and outputting the banknotes to said bundled banknote payment port;
(15) a bundle payment function of discriminating between the banknotes fed out from said banknote storage portions by said payment discriminating portion, bundling the banknotes of the denomination concerned by said bundling portion, feeding out, in the case of outputting the banknote bundle of the denomination that is not assigned to said banknote bundle storage portion, the banknotes from said banknote storage portion, bundling the fed-out banknotes by said bundle handling unit, and outputting the bundled banknotes to said bundled banknote payment port; and
(16) a banknote bundle output port collecting function of taking out the banknote bundles from said designated banknote bundle storage portion, discriminating between the banknote bundles by said bundle discriminating portion, outputting the banknote bundles from said bundle output port, and outputting the banknote bundles to said bundle output port,
said coin deposit/payment sorting machine including, as a range of components,: a loose coin input port into which the loose coins are inputted; a coin discriminating portion that discriminates between the handling target coins about authenticity, fitness and denominations; coin temporary holding portions according to the denominations; a coin batch manner temporary holding portion that reserves batch manner the coins irrespective of the denominations; coin storage portions that store the coins according to the denominations; a coin wrapping portion that accumulates and packs a predetermined number of coins; a loose coin payment box; a wrapped coin output port; a wrapped coin payment port; wrapped coin storage portions; a bag storage oriented output port; a reject box; a return box; an out-of-machine fraction box; a wrapped coin batch manner storage box,
said coin deposit/payment sorting machine having the following functions such as:
(17) a loose coin deposit function of taking in the loose coins set in said loose coin input port, discriminating between the coins by said coin discriminating portion, storing the fit coins, after being temporarily reserved in said coin temporary holding portions according to the denominations, in said coin storage portions of the denominations concerned, then storing the unfit, after being temporarily reserved in said coin batch manner reserving portion, in said batch manner coin storage box, and returning, if cancelled, all the coins;
(18) a loose coin input port loading function of taking in the loose coins set in said loose coin input port, discriminating between the coins by said coin discriminating portion, storing the fit coins, after being temporarily reserved in said coin temporary holding portion according to the denominations, in said coin storage portions of the denominations concerned, and immediately returning the unfit coins as reject coins;
(19) a sorting function of taking in the loose coins set in said loose coin input port, discriminating between the coins by said coin discriminating portion, wrapping the fit coins by said coin wrapping portion, and outputting the wrapped coins from said wrapped coin output port;
(20) an in-bag function of taking in the loose coins set in said loose coin input port, counting the coins, and outputting the coins from said bag storage oriented output port;
(21) a loose coin payment function of feeding out a designated number of loose coins of a designated denomination, and outputting the loose coins into said payment box;
(22) a loose coin auto collecting function of automatically feeding out the loose coins from said coin storage portions if a storage count in each of said storage portions becomes equal to or larger than a fixed count on the basis of a customer's setting (the setting registered in the device) or when any one of said storage portions becomes full of the coins, wrapping the coins by said coin wrapping portion and storing the coins in said wrapped coin batch manner storage box, and an intra-machine moving loading function by which a customer himself or herself arbitrarily executes a process of wrapping the coins in said coin storage portions by said coin wrapping portion in accordance with states of said respective storage portions and storing the coins in said wrapped coin batch manner storage box;
(23) a loose coin denomination-based storage portion collecting function of feeding out the loose coins from said coin storage portion of the designated denomination, and discharging the coins to said loose coin payment box;
(24) a wrapped coin input port loading function of taking in the loose coins set in said loose coin input port, discriminating between the coins by said coin discriminating portion, wrapping the fit coins by said coin wrapping portion according to the denominations, and storing the wrapped coins in said wrapped coin batch manner storage box;
(25) a wrapped coin payment function of feeding out a designated number of wrapped coins of a designated denomination from said wrapped coin storage portions, and discharging the wrapped coins to said wrapped coin payment port;
(26) a loose coin pack collecting function of feeding out the loose coins from said coin storage portion of the designated denomination, wrapping the loose coins by said coin wrapping portion, and outputting the wrapped coins from said wrapped coin output port to the outside of said machine;
(27) a wrapped coin output port collecting function of feeding out the wrapped coins stored in said wrapped coin storage portions, and outputting the wrapped coins from the wrapped coin output port to the outside of said machine; and
(28) a wrapped coin payment port collecting function of feeding out the wrapped coins stored in said wrapped coin storage portions, and discharging the wrapped coins to said wrapped coin payment port,
wherein arbitrary functions among said functions (1) through (28) can be set.

10. A banknote and coin handling system according to claim 9, wherein said banknote deposit/payment sorting machine and said coin deposit/payment sorting machine are combined so as to have at least the same height.

11. A banknote and coin handling system according to claim 10, wherein a new banknote payment unit paying pre-stored new banknotes in response to an instruction is further combined.

12. A banknote and coin handling system according to claim 9, wherein said banknote deposit/payment sorting machine is constructed of a loose banknote deposit/payment unit and a bundled banknote deposit/payment unit.

13. A banknote and coin handling system according to claim 9, wherein said coin deposit/payment sorting machine is constructed of a coin deposit/payment unit and a wrapped coin payment unit.

14. A banknote and coin handling system according to claim 9, further comprising a careful inspection function of calculating intra-machine money data from values and the number of all the banknotes and coins contained in said system.

15. A banknote and coin handling system according to claim 9, wherein said intra-machine moving loading function is automatically conducted about the denomination when any one of said storage portions gets full of the banknotes or the coins.
